(19) United States
(12) Patent Application Publication
(10) Pub. No.: US 2019/0067690 A1
(43) Pub. Date: Feb. 28, 2019

(54) LIQUID METAL-BASED COMPOSITIONS

(71) Applicant: UWM Research Foundation, Inc., Milwaukee, WI (US)

(72) Inventors: Junhong Chen, Whitefish Bay, WI (US); Yingpeng Wu, Shorewood, WI (US)

(21) Appl. No.: 16/046,845

(22) Filed: Jul. 26, 2018

Related U.S. Application Data
(60) Provisional application No. 62/537,300, filed on Jul. 26, 2017.

(51) Int. Cl. H01M 4/38; H01M 4/36

(52) U.S. Cl. CPC H01M 4/387; H01M 4/38; H01M 4/366

(57) ABSTRACT

Compositions that include liquid metal particles and a carbon-based scaffold are disclosed. The composition may be used in a number of different applications, including battery and capacitor applications. Also disclosed are methods of making liquid metal-based compositions.

### CROSS-REFERENCE TO RELATED APPLICATIONS

This application claims priority to U.S. Provisional Patent Application No. 62/537,300, filed Jul. 26, 2017, which is incorporated herein by reference in its entirety.

### TECHNICAL FIELD

This disclosure relates to self-healing, liquid metal-based compositions and their use in electrochemical cells, such as batteries.

### BACKGROUND

Due to significant advancements in technology, energy storage is one of the most important research topics in this century. Electrical energy storage is the most convenient form of storage due to its high conversion efficiency and absence of gaseous exhaust. The lithium-ion battery (LIB) has become the dominant power source for portable electronics and it has shown promise for electric vehicles/plug-in hybrid electric vehicles, and even large-scale renewable energy storage systems. The foremost challenge for high-performance anode materials is their capacity decay, which is attributed to inadequate cycling stability.

LIB cycle performance decay is usually caused by volume expansion/contraction during lithiation and delithiation reactions. Such a volume change can result in crack formation, detach active materials from the current collector, and/or break down the electronically conductive network within the electrode, all of which can deactivate the Li⁺ storage ability and lead to inferior cycle performance. To overcome these problems, extensive efforts have been devoted to improving electrode durability, mainly through three approaches: (1) alloying the Li-active materials with inactive elements, (2) building nanostructured electrodes, and (3) adding buffer components. These approaches can improve LIB cycle life, but they do not improve the intrinsic limit of the Li-active materials. The addition of inactive or buffer materials decreases the specific capacity, and the addition of nanostructured electrodes increases the cost for a viable battery. Accordingly, improved strategies and compositions are needed to improve LIB performance.

### SUMMARY

In one aspect, disclosed are compositions comprising a plurality of liquid metal particles; and a carbon-based scaffold comprising at least one of carbon nanotubes, reduced graphene oxide, carbon derived from an annealed carbon precursor, and a combination thereof.

In another aspect, disclosed are batteries comprising a first electrode comprising a composition as disclosed herein; a second electrode; an electrolyte; and a separator.

In another aspect, disclosed are methods of making a liquid metal-based composition, the method comprising mixing at least two metals at a temperature of about 100° C. to about 1,000° C. to provide a liquid metal alloy; adding a surfactant to the liquid metal alloy and mechanically, electrically or both dispersing the surfactant and the liquid metal alloy to provide a plurality of liquid metal particles; mixing the plurality of liquid metal particles with at least one of carbon nanotubes, graphene oxide, a carbon precursor and a combination thereof to provide a mixture; and annealing the mixture to provide a composition as disclosed herein.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1A-FIG. 1D: (FIG. 1A) Synthesis procedure for reduced graphene oxide (RGO)/carbon nanotubes (CNTs)-supported liquid metal nanoparticle (LMNP) anode. (FIG. 1B) Ga and Sn in the solid state and the liquid metal (LM) alloy in liquid state at room temperature (RT). (FIG. 1C) LMNPs after sonication. (FIG. 1D) LMNPs embedded in a carbon skeleton forming a 3D structure.

FIG. 2A-FIG. 2F: (FIG. 2A) The surface of the LM before charging. (FIG. 2B) The LM at full lithiation state, with a notable surface roughness increase with bumps and ravines. (FIG. 2C) The LM at full delithiation state, with bumps and ravines disappearing and the surface becoming smooth again. (FIG. 2D) Scanning electron microscopy (SEM) image of a LMNP electrode before cycling. (FIG. 2E) SEM image of an LMNP electrode after cycling. (FIG. 2F) Cycle test of LMNPs only, without supporting RGO/CNTs.

FIG. 3A-FIG. 3E: (FIG. 3A) The long cycle test of a LIB based on a LMNP anode. (FIG. 3B) SEM image and (FIG. 3C) energy-dispersive X-ray spectroscopy (EDS) result of a 3D LMNP electrode before cycling. (FIG. 3D) SEM image and (FIG. 3E) EDS result of a 3D LMNP electrode after 300 cycles.

FIG. 4A-FIG. 4D: (FIG. 4A) Electrochemical impedance spectroscopy (EIS) tests of a battery before and after cycling. (FIG. 4B) Cyclic voltammetry (CV) curve at 0.05 mV/s. (FIG. 4C) Rate capability. (FIG. 4D) The charge/discharge curves under different rates.

FIG. 5A-FIG. 5H: (FIG. 5A) is an overlay image of SEM and the C, Ga, and Sn EDS images before cycling, (FIG. 5E) is that after cycling. EDS mapping images for C, Ga, and Sn before and after cycling, (FIG. 5B-FIG. 5D) C, Ga and Sn separately before cycling, (FIG. 5F-FIG. 5H) C, Ga, and Sn separately after cycling.

FIG. 6: Control experiment using an electrode without CNTs shows the cycle life is less than 900 cycles.

FIG. 7A-FIG. 7D: (FIG. 7A) LMNPs suspension in ethanol after sonication. (FIG. 7B) Precipitated LMNPs after 24 h. (FIG. 7C) LMNPs mixed with graphene oxide (GO) gel after 24 h. (FIG. 7D) LMNPs mixed with CNTs and GO gel after 24 h. The arrow shows the gravity direction.

FIG. 8: Raman spectra of GO and RGO after thermal treatment.

FIG. 9A-FIG. 9B: Anode material before (FIG. 9A) and after (FIG. 9B) vibration test. There was no change in the size and shape of the LMNPs.

FIG. 10A-FIG. 10B: SEM images of an anode material before (FIG. 10A) and after (FIG. 10B) the dropping.

FIG. 11: CV curves before and after dropping are overlapping, indicating a high stability of the anode.

FIG. 12A-FIG. 12B: (FIG. 12A) First charge/discharge performance of RGO, CNT, LMNP with a current of 200 mA/g. (FIG. 12B) First charge/discharge performance of 3D LMNP anode with a current of 200 mA/g.

FIG. 13A-FIG. 13B: Capacity and rate performance of CNTs (FIG. 13A) and RGO (FIG. 13B) under different rates.

FIG. 14: Curves of different cycle numbers.

FIG. 15A-FIG. 15C: (FIG. 15A) SEM image of an anode before cycling. (FIG. 15B) SEM image of an anode after more than 4,500 cycles. (FIG. 15C) the high-magnification image of an anode, showing the LMNPs.

FIG. 16: Nyquist plots of a battery before and after cycling at the fully charged state.

FIG. 17A-FIG. 17B: LM particles with 1ATC9 (FIG. 17A) are much smaller than those without 1ATC9 (FIG. 17B) after sonication.

FIG. 18A-FIG. 18B: A Ga—Sn alloy before (FIG. 18A) and after 900° C. annealing (FIG. 18B); both are in the liquid state.

FIG. 19A-FIG. 19F: (FIG. 19A) Schematic illustration of the synthesis of Si and LM composite (SLC), (FIG. 19B) SEM image and (FIG. 19C-FIG. 19F) EDS elemental mapping of SLC.

FIG. 20A-FIG. 20G: (FIG. 20A) Long-term cycling performance of a LIB based on a SLC anode, (FIG. 20B) cycling performance of the control material without the protection of LM, (FIG. 20C) SEM image, and (FIG. 20D-FIG. 20G) EDS mapping of 3D SLC.

FIG. 21A-FIG. 21C: (FIG. 21A) Rate capability of a SLC, (FIG. 21B) charge/discharge curves under different rates, and (FIG. 21C) CV curve of the SLC at 0.05 mV/s.

FIG. 22A-FIG. 22D: (FIG. 22A) Cycling performance and (FIG. 22B) rate capability of SLC₂ᵥ₁, and (FIG. 22C) cycling performance and (FIG. 22D) rate capability of SLC₁ᵥ₁.

FIG. 23A-FIG. 23B: (FIG. 23A) LM drop on a separator surface with a contact angle of 144°, and (FIG. 23B) a carbon skeleton-supported SLC.

FIG. 24: Relation between electrode areal capacity and the mass loading.

FIG. 25A-FIG. 25F: SEM images of (FIG. 25A) SLC_{2V1}, (FIG. 25B) SLC_{1V1} and (FIG. 25C) SLC before cycling, and (FIG. 25D) SLC_{2V1}, (FIG. 25E) SLC_{1V1}, and (FIG. 25F) SLC after cycling.

FIG. 26: Schematic of electrospinning LM and carbon fiber anode materials.

FIG. 27: Images of flexible anodes made via electrospinning.

FIG. 28: Long-term cycling performance of a LIB based on a freestanding LMNP@carbon fiber anode.

FIG. 29: Rate performance of a LIB based on a freestanding LMNP@carbon fiber anode.

FIG. 30: Rate performance of a LIB based on a freestanding LMNP@carbon fiber anode: charge/discharge curves under different rates.

### DETAILED DESCRIPTION

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. Compositions

Disclosed herein are compositions that comprise a plurality of liquid metal particles, and a carbon-based scaffold, wherein the carbon-based scaffold comprises at least one of carbon nanotubes, reduced graphene oxide, carbon derived from an annealed carbon precursor, and a combination thereof. The compositions may also be referred to as liquid metal-based compositions. Each of the plurality of liquid metal particles and the carbon-based scaffold can instill certain advantages to the composition. The liquid metal particles can provide a self-healing property to the composition, which can be due to the fluidity and the surface tension of the liquid metal. For example, the self-healing property of the liquid metal and composition thereof may avoid the expansion and/or contraction-induced cracking of battery electrodes during cycling. As such, the compositions have advantageous properties that make them useful for battery applications. Regarding the carbon-based scaffold, it may improve mechanical properties of the composition as it can act as a scaffold in which the plurality of liquid metal particles are embedded therein. In addition to the mechanical properties provided, the carbon-based scaffold may improve the electrical conductivity of the composition. The combination of the liquid metal particles and the carbon-based scaffold may result in the composition having a porous structure.

The composition may have an advantageous carbon content which can be useful for improved electrochemical performance. For example, the composition may have a carbon content of about 5 wt % to about 50 wt % as measured by wt % of the composition, such as about 5 wt % to about 20 wt %, about 15 wt % to about 25 wt %, or about 18 wt % to about 22 wt % as measured by wt % of the composition. In some embodiments, the carbon content consists essentially of the carbon-based scaffold. In some embodiments, the carbon content consists of the carbon-based scaffold. In some embodiments, the carbon content consists essentially of carbon nanotubes and reduced graphene oxide. In some embodiments, the carbon content consists of carbon nanotubes and reduced graphene oxide. In some embodiments, the carbon content consists essentially of carbon derived from an annealed carbon precursor. In some embodiments, the carbon content consists of carbon derived from an annealed carbon precursor.

The composition may further comprise other particles that can instill advantageous properties to the compositions. For example, the composition may also include silicon particles, tin particles, aluminum particles, or a combination thereof.

In addition, the compositions may further comprise a magnetic component and stretchable elements such as liquid rubbers such that the shape of the composition and/or its rheological properties can be altered through induced magnetic contact. In some embodiments, the magnetic component is associated with the liquid metal particles and the stretchable element is associated with the carbon nanotubes and/or reduced graphene oxide. The compositions may also include other suitable 2-D materials such as MXene (transition metal carbides, nitrides or carbonitrides like Ti₂C, V₂C, Nb₂C, Mo₂C, Ti₃C₂, Ti₃CN, Zr₃C₂, Ti₄N₃, Nb₄C₃, Ta₄C₃, Mo₂TiC₂, Cr₂TiC₂, and Mo₂Ti₂C₃) and 1-D materials, including nanorods generated out of materials like silicon, tin oxide, or other metal oxide materials.

Other than battery applications, the compositions may also be used in capacitor applications and to provide self-healing circuits that may be generated through deposition of the composition by ink jet, rotogravure or flexographic printing or otherwise.

In some embodiments, the composition consists essentially of a plurality of liquid metal particles, a plurality of carbon nanotubes, and reduced graphene oxide. In some embodiments, the composition consists of a plurality of liquid metal particles, a plurality of carbon nanotubes, and reduced graphene oxide. In some embodiments, the composition consists essentially of a plurality of liquid metal particles, a plurality of carbon nanotubes, reduced graphene oxide, and a plurality of silicon particles. In some embodiments, the composition consists of a plurality of liquid metal particles, a plurality of carbon nanotubes, reduced graphene oxide, and a plurality of silicon particles. In some embodiments, the composition consists essentially of a plurality of liquid metal particles, and carbon derived from an annealed carbon precursor. In some embodiments, the composition consists of a plurality of liquid metal particles, and carbon derived from an annealed carbon precursor. In some embodiments, the composition consists essentially of a plurality of liquid metal particles, carbon derived from an annealed carbon precursor, and a plurality of silicon particles. In some embodiments, the composition consists of a plurality of liquid metal particles, carbon derived from an annealed carbon precursor, and a plurality of silicon particles.

A. Liquid Metal Particles

As used herein, “liquid metal” refers to a metal having a melting temperature that is below the operating temperature of a battery that includes the liquid metal. In addition, the liquid metal is capable of ion insertion and/or hosting ion atoms, where the ion is an ion that can be used in battery applications. Exemplary ions include, but are not limited to, Li ion, K ion, Mg ion and Na ion. In an exemplary embodiment, the liquid metal is capable of Li insertion and/or hosting Li atoms. The term liquid metal is inclusive of alloys. In some embodiments, the liquid metal has a melt temperature of about −60° C. to about 235° C., such as about −60° C. to about 100° C., about −30° C. to about 50° C., or about −10° C. to about 30° C. Examples of liquid metals include, but are not limited to, gallium and alloys of gallium, indium, and/or tin. Specific examples of liquid metals include, but are not limited to, those set forth in Table 1.

TABLE 1
Liquid Metal Compositions

| Composition | w.t. % | melting point (° C.) |
|---|---|---|
| Zn:Ga | 3.6:96.4 | 24.6 |
| In:Ga | 76:24 | 16 |
| Ga:In:Sn | 62.5:21.5:16 | 17 |
| Ga:In:Sn:Zn | 61:25:13:1 | 7.6 |
| Hg | | −39 |
| Tl:Hg | 8.7:91.3 | −59 |
| Ag:Ga | 34:66 | 25 |

The liquid metal may comprise at least two metals selected from the group consisting of: Ga, Sn, Hg, Tl, Zn, In, Bi, Pb and Ag. In other embodiments, the liquid metal may comprise a single metal. In some embodiments, the liquid metal comprises Ga and Sn. In some embodiments, the liquid metal is selected from the group consisting of Ga₅₅₋₆₅In₁₅₋₂₅Sn₁₂₋₂₀, Ga₅₅₋₆₅In₂₀₋₃₀Sn₁₀₋₁₅Zn_{0.5-5}, Hg, Tl₅₋₁₅Hg₈₅₋₉₅, Ag₂₅₋₄₀Ga₆₀₋₇₅, and Ga₈₀₋₉₅Sn₅₋₂₀, wherein a subscript denotes an element's weight (wt) % of the liquid metal. In some embodiments the liquid metal is selected from Zn_{3.6}Ga_{96.4}, In₇₆Ga₂₄, Ga_{62.5}In_{21.5}Sn₁₆, Ga₆₁In₂₅Sn₁₃Zn₁, Hg, Tl_{8.7}Hg_{91.3}, Ag₃₄Ga₆₆, and Ga₈₈Sn₁₂, wherein a subscript denotes an element's weight (wt) % of the liquid metal. In some embodiments, the liquid metal is selected from Zn_{3.6}Ga_{96.4}, In₇₆Ga₂₄, Ga_{62.5}In_{21.5}Sn₁₆, Ga₆₁In₂₅Sn₁₃Zn₁, Ag₃₄Ga₆₆, and Ga₈₈Sn₁₂, wherein a subscript denotes an element's weight (wt) % of the liquid metal. In yet other embodiments, the liquid metal is Ga₈₈Sn₁₂, wherein a subscript denotes an element's weight (wt) % of the liquid metal.

The liquid metal may be in the form of particles, such as nanoparticles, microparticles or a combination thereof. In some embodiments, the liquid metal particles may each independently have a diameter of about 1 nm to about 2 μm, such as about 1 nm to about 500 nm, about 20 nm to about 500 nm or about 50 nm to about 500 nm.

In addition, the liquid metal particles may be modified by a surfactant. For example, the plurality of liquid metal particles may each independently have a surface that is modified by a surfactant. The surfactant can covalently bind to the surface of a liquid metal particle, e.g., by means of a —SH, —NH or —OH bond. In some embodiments, the surfactant can be covalently bonded to the surface of a liquid metal particle by means of a —SH. The surfactant may also contain other functional groups as necessary to lower surface tension between the liquid metal and solvent during synthesis of the liquid metal particles. An exemplary surfactant is 3-Mercapto-N-nonylpropionamide (1ATC9). In some embodiments, variants in which the nonyl chain length are increased (e.g., by 2 to 10 carbons) or decreased (e.g., by 1 to 4 carbons) are expected to be suitable surfactants.

The liquid metal particles may be included in the composition at varying amounts. For example, the plurality of liquid metal particles may be present at about 5 wt % to about 95 wt % as measured by wt % of the composition, such as about 10 wt % to about 95 wt %, about 25 wt % to about 95 wt %, about 30 wt % to about 90 wt %, about 70 wt % to about 90 wt %, or about 75 wt % to about 85 wt % as measured by wt % of the composition. In some embodiments, the liquid metal particles are homogenously dispersed throughout the composition.

B. Carbon-Based Scaffold

The carbon-based scaffold can prevent or limit aggregation of the liquid metal particles, detachment of the liquid metal particles from a current collector (e.g., in a battery applications), or both. In addition, the carbon-based scaffold can act as a 3-D structure that can preserve the size, shape or both of the liquid metal particles, thereby it can maintain the structure of the composition, even in situations where the liquid metal particles expand and constrict, e.g., when the composition is used as a battery electrode. The liquid metal particles may be described as being embedded within the carbon-based scaffold. The liquid metal particles may also be described as being homogeneously dispersed within and/or embedded within the carbon-based scaffold. The carbon-based scaffold may include at least one of carbon nanotubes, reduced graphene oxide, carbon derived from an annealed carbon precursor, and a combination thereof. In some embodiments, the carbon-based scaffold includes reduced graphene oxide and at least one of carbon nanotubes, carbon derived from an annealed carbon precursor, and a combination thereof. The carbon-based scaffold may also include carbon fibers, such as commercially available carbon fibers and/or fibers that comprise carbon derived from an annealed carbon precursor. The carbon fibers may have a diameter of about 0.5 nm to about 7 μm.

Carbon nanotubes are allotropes of carbon with a cylindrical nanostructure, which have advantageous properties such as useful mechanical properties and electrical properties that make them useful for inclusion within the disclosed compositions. The CNTs or carbon fiber can be single or multi walled carbon nanotubes, and may have a diameter of about 0.5 nm to about 7 nm. In addition, the length of the CNTs can be about 1 μm to about 1 mm. The CNTs can be undoped or doped by N, O, S or other elements commonly used to dope CNTs. In some embodiments, the carbon nanotube is an acid treated carbon nanotube, which can aid in dispersibility during synthesis of the compositions, as well as may remove amorphous carbon and catalyst. The carbon nanotubes may be present in the composition at about 1 wt % to about 20 wt %, as measured by wt % of the composition, such as about 8 wt % to about 20 wt %, about 11 wt % to about 19 wt %, or about 12 wt % to about 18 wt % as measured by wt % of the composition.

Graphene oxide (GO) is a graphene-based material which can be mass-produced at a lower cost compared to pure graphene. GO can be synthesized in large quantities by oxidizing inexpensive graphite powders using strong oxidants. While unreduced GO is insulating, reducing the GO (RGO) partially allows the GO to be more conductive. GO can also be reduced through different methods with tailored properties by controlling the reduction conditions. Examples of reduced graphene oxide include, but are not limited to, thermally-reduced graphene oxide, chemically-reduced graphene oxide, and doped-reduced graphene oxide. In some embodiments, the reduced graphene oxide is derived from thermally reducing graphene oxide, e.g., by annealing at temperatures as discussed below in the Methods of Making and Example sections. The reduced graphene oxide can be a single layer or include a few layers (e.g., 2 to 6 layers) of reduced graphene oxide. The reduced graphene oxide can have dimensions of about 100 nm to about 100 μm. In addition, the reduced graphene oxide can be doped by N, O, S or other commonly used dopants for graphene oxide and/or reduced graphene oxide. The reduced graphene oxide may be present in the composition at about 1 wt % to about 20 wt % as measured by wt % of the composition, such as about 1 wt % to about 10 wt %, about 2 wt % to about 8 wt %, or about 3 wt % to about 7 wt % as measured by wt % of the composition.

In some embodiments, the carbon-based scaffold comprises a plurality of carbon nanotubes and reduced graphene oxide. The combination of the carbon nanotubes and reduced graphene oxide may be included in the composition at varying amounts. For example, the combination of the carbon nanotubes and reduced graphene oxide may be present at about 1 wt % to about 25 wt % as measured by wt % of the composition, such as about 1 wt % to about 20 wt %, about 1 wt % to about 15 wt % or about 2 wt % to about 10 wt % as measured by wt % of the composition. In some embodiments, the carbon-based scaffold consists essentially of a plurality of carbon nanotubes and reduced graphene oxide. In some embodiments, the carbon-based scaffold consists of a plurality of carbon nanotubes and reduced graphene oxide.

The carbon can be derived from annealing a carbon precursor, such as at the annealing temperatures discussed below in the Methods of Making and in the Examples. Examples of carbon precursors that can be annealed to provide the carbon include, but are not limited to, polymers such as polyacrylonitrile (PAN), polyvinyl chloride, polyvinyl alcohol, polyethylene, polyethylene oxide and phenolic resin. In some embodiments, the carbon is derived from an annealed polymer. In some embodiments, the carbon is derived from annealed PAN, annealed polyvinyl chloride, annealed polyvinyl alcohol, annealed polyethylene, annealed polyethylene oxide, annealed phenolic resin, or a combination thereof. In some embodiments, the carbon is derived from annealed PAN. Embodiments where the carbon is derived from annealed PAN, the carbon may be graphitized carbon, pure graphitized carbon, or N-doped carbon based on the carbonization process. In some embodiments, the carbon-based scaffold consists essentially of carbon derived from an annealed polymer. In some embodiments, the carbon-based scaffold consists of carbon derived from an annealed polymer. In some embodiments, the carbon-based scaffold consists essentially of carbon derived from annealed PAN.

The carbon precursor can be suitable for electrospinning applications. In some embodiments, the carbon is derived from an electrospun and annealed polymer. For example, the carbon precursor can be electrospun to provide fibers including the carbon precursor. The fiber can then be annealed at temperatures as described herein to provide fibers including the carbon derived from an annealed carbon precursor. As such, the composition and/or carbon-based scaffold can include carbon derived from an annealed carbon precursor (e.g., polymer) in the form of a plurality of fibers. In some embodiments, the carbon precursor can be electrospun with the liquid metal particles and annealed to provide a composition comprising a carbon-based scaffold that includes carbon derived from the carbon precursor and liquid metal particles embedded within the carbon-based scaffold. In some embodiments, the composition comprises a plurality of fibers, each fiber having a liquid metal particle core surrounded by a carbon coating—the carbon coating being derived from a carbon precursor. The fibers may have void space in between the carbon coating and the liquid metal particles, which can allow for improved cycle performance when used in, e.g., battery applications.

C. Silicon Particles

Silicon has a high theoretical capacity for battery applications and in particular Li ion batteries. However, silicon suffers from significant volume expansion during lithiation. When used in combination with the liquid metal particles and the carbon-based scaffold of the disclosed compositions, the aforementioned issues of silicon may be alleviated. Embodiments that include silicon particles, can include the silicon particles as being surrounded by the liquid metal particles. The liquid metal particles surrounding the silicon particles may be described as being embedded within the carbon-based scaffold. In some embodiments, the silicon particles are homogenously dispersed throughout the composition.

The silicon particles may be modified prior to inclusion in the composition. For example, the silicon particles may each independently have a surface that can be modified by different hydrophilic functional groups. In some embodiments, the silicon particles each independently have a surface that is modified by a hydroxyl group. The term “hydroxyl” as used herein, means an —OH group.

The composition may include the silicon particles at varying weight ratios. For example, the composition may include the silicon particles at a weight ratio (silicon particles:liquid metal particles) of about 4:1 to about 1:4, such as about 4:1 to about 1:2, about 3:1 to about 1:3, or about 2:1 to about 1:2.

In addition, the silicon particles may each independently have a diameter of about 10 nm to about 500 nm. In some embodiments, the silicon particles have an average diameter of about 100 nm.

D. Methods of Making Liquid Metal-Based Compositions

In another aspect, disclosed are methods of making liquid metal-based compositions. The method may include mixing at least two metals at a temperature of about 100° C. to about 1,000° C. (e.g., above the metals' melting temperatures) to provide a liquid metal alloy. The mixing can be performed for a period of time, such as about 30 minutes to about 5 hours. In some embodiments, the at least two metals are mixed at about 300° C. for about 2 hours. In addition, the mixing can be performed in air-free conditions, such as under argon. The liquid metal alloy may be allowed to cool down to room temperature following mixing. The at least two metals can be selected from the group consisting of: Ga, Sn, Hg, Tl, Zn, In, Bi, Pb and Ag. In some embodiments, the at least two metals are selected from the group consisting of Ga, Sn, Zn and In.

The method can further include adding a surfactant to the liquid metal alloy and mechanically, electrically or both dispersing the surfactant and the liquid metal alloy to provide a plurality of liquid metal particles. In some embodiments, the liquid metal alloy is dispersed via sonication. The liquid metal particles can be sedimented in order to isolate particles of specific size ranges. The isolated liquid metal particles may each independently have a diameter of about 1 nm to about 500 nm, such as about 20 nm to about 500 nm or about 50 nm to about 500 nm. The liquid metal particles may also be dried at about 30° C. to about 60° C., such as about 50° C.

The plurality of liquid metal particles may then be mixed with at least one of carbon nanotubes, graphene oxide, a carbon precursor and a combination thereof to provide a mixture. The mixture can further include a solvent. An exemplary solvent is alcohol, such as ethanol. The carbon nanotubes may be treated with an acid prior to adding to the mixture. The mixture may be sonicated following addition of the liquid metal particles and at least one of carbon nanotubes, graphene oxide, a carbon precursor and a combination thereof.

In some embodiments, the plurality of liquid metal particles are mixed with a plurality of carbon nanotubes and graphene oxide to provide a mixture. In some embodiments, the carbon nanotubes are added prior to the graphene oxide. In other embodiments, the carbon nanotubes are added at the same time as the graphene oxide.

The mixture can be annealed to provide a composition as disclosed herein. The mixture can be annealed at a temperature of about 500° C. to about 2000° C., such as about 700° C. to about 1000° C., about 750° C. to about 950° C. or about 800° C. to about 900° C. Annealing can be performed for about 1 hour to about 10 hours. The method may also include a solvothermal process prior to the annealing step.

The method may further include adding silicon particles to the plurality of liquid metal particles prior to mixing with at least one of carbon nanotubes, graphene oxide, a carbon precursor and a combination thereof. In some embodiments, the silicon particles are added to the plurality of liquid metal particles, and then a plurality of carbon nanotubes and graphene oxide are added to provide a mixture. In some embodiments, the silicon particles may be surface modified via the addition of a hydroxyl group to a surface of the silicon particle.

In some embodiments, the composition can be provided by electrospinning methods. For example, the plurality of liquid metal particles and at least one of carbon nanotubes, graphene oxide, a carbon precursor and a combination thereof can be prepared as a solution in a solvent. The solvent can be an organic solvent, such as dimethylformamide (DMF). The solution can include the liquid metal particles at about 5 mg/ml to about 500 mg/ml, such as about 10 mg/ml to about 40 mg/ml or about 15 mg/ml to about 30 mg/ml. In addition, the solution may include the at least one of carbon nanotubes, graphene oxide, a carbon precursor and a combination thereof at about 5 wt % to about 25 wt % as measured by weight of the solution, such as about 8 wt % to about 20 wt % or about 9 wt % to about 15 wt % as measured by weight of the solution. In some embodiments, the plurality of liquid metal particles are in a first solution and the at least one of carbon nanotubes, graphene oxide, a carbon precursor and a combination thereof is in a second solution.

The solution can be electrospun using, e.g., a syringe needle and the as-spun fibers can be collected on a rotating collecting drum. The fibers can be annealed at a temperature of about 500° C. to about 2000° C., such as about 700° C. to about 1000° C., about 750° C. to about 950° C. or about 800° C. to about 900° C. Annealing can be performed for about 1 hour to about 10 hours. In some embodiments, the fibers are exposed to an additional annealing step prior to the foregoing annealing. For example, the fibers may be annealed first at about 350° C. to about 500° C. for 0.25 h to about 1 h under argon. These fibers may then be annealed at a higher temperature as discussed above. In some embodiments, the annealed fibers are described as fiber felts.

In some embodiments, the electrospinning method can include a first solution comprising the plurality of liquid metal particles and optionally a polymer; and a second solution including the carbon precursor. The first solution and the second solution can be electropun coaxially, and can provide fibers having an outer layer comprising the carbon precursor and inner layer comprising the plurality of liquid metal particles and optional polymer. After annealing, the fiber can comprise an outer layer of carbon derived from the carbon precursor and an inner core that comprises the plurality of liquid metal particles, where residual carbon from the polymer of the first solution (if included) is very low and may not be used as a carbon source within the fiber and/or composition.

Generally, the above-description under the “Compositions” section regarding the liquid metal particle and scaffold materials can also be applied to the methods of making the liquid metal-based compositions. For the purposes of brevity, this description will not be repeated here.

### 3. Batteries

In another aspect, disclosed are batteries that can include the compositions as described herein. In particular, the battery can include an electrode comprising the composition. The electrode comprising the composition may be referred to as a first electrode. The battery may also include a second electrode, an electrolyte, and a separator.

The first electrode may include the composition at a mass loading of about 0.3 mg/cm² to about 10 mg/cm², such as about 0.4 mg/cm² to about 5 mg/cm² or about 0.5 mg/cm² to about 2 mg/cm². In some embodiments, the first electrode consists essentially of the composition. In some embodiments, the first electrode consists of the composition. The first electrode may be an anode or a cathode, with the second electrode being the other. In some embodiments, the first electrode is an anode. In some embodiments, the first electrode does not contain molten salts that are solid below a battery's operating temperature and that become a liquid phase during battery operation, which is typically greater than 400° C. for these type of salts.

The second electrode may include suitable materials that are useful in battery applications. In some embodiments, the second electrode comprises Lithium (Li), LiCoO₂, LiFePO₄, LiFeSiO₄, LiMn₂O₄, sulfur, sulfide, a salt of Li, a salt of sodium (Na), a salt of Potassium (K), a salt of Magnesium (Mg), a salt of Aluminum (Al) or a combination thereof. In some embodiments, the second electrode comprises Lithium (Li), LiCoO₂, LiFePO₄, LiFeSiO₄, LiMn₂O₄, or a combination thereof. In some embodiments, the second electrode does not include a liquid metal or particle thereof. In some embodiments, the second electrode does not include molten salts.

The electrolyte may be any suitable salt that is useful in battery applications. Examples include, but are not limited to, salts of Li, salts of Sodium (Na), salts of Potassium (K), salts of Magnesium (Mg), and salts of Aluminum (Al). In some embodiments, the electrolyte comprises a salt of Li, a salt of Na, a salt of K, a salt of Mg, a salt of Al, or a combination thereof. In some embodiments, the electrolyte comprises a salt of Li. An exemplary Li salt is LiPF₆.

The separator may include a polymer or a combination of polymers. Examples of polymers include, but are not limited to, polypropylene, polyethylene and other polyolefins. In some embodiments, the separator comprises a material that provides poor wettability of the liquid metal particles. For example, the separator may comprise a material having a surface where the liquid metal particles have a contact angle of greater than 120° on the material's surface, greater than 130° on the material's surface, or greater than 140° on the material's surface. In some embodiments, the separator is a trilayer of porous polymers such as a polypropylene/polyethylene/polypropylene trilayer.

An electrode comprising the composition may be fabricated by commercial electrode processing techniques. For anodes, these include mechanical mixing with carbon black, binder, solvent (e.g. water) to form slurries, subsequent coating techniques involving doctor blades and heated drying. Cathode embodiments, although can be generated from different materials (e.g. Li-M-PO₄, poly(vinylidene difluoride), and different accompanying solvents (e.g. N-methyl-2-pyrolidone), can involve similar manufacturing techniques. Embodiments for battery anodes and cathodes may involve different current collector metals, however, the slurry manufacture deposition is unlikely to be affected.

The battery may be operated at a broad range of temperatures where the liquid metal can remain in liquid form during operation. In some embodiments, the battery has an operating temperature of about −60° C. to about 235° C., such as about −60° C. to about 100° C., about −30° C. to about 50° C., or about −10° C. to about 30° C. In some embodiments, the composition remains in liquid form throughout ion insertion and ion removal. For example, the composition may remain in liquid form during lithiation and delithiation when used in a Li-ion battery.

The battery may also have advantageous properties due to the inclusion of the first electrode comprising the compositions disclosed herein, such as mitigating capacity loss due to cracking due to volume change of the electrode. For example, the battery may provide a capacity of about 50 mAh/g to about 1,000 mAh/g at 2,000 mA/g after 1,000 cycles. In addition, the battery including the disclosed compositions may have improved cycle performance, such as the first electrode being stabilized and maintained for greater than 4000 cycles. C rate behavior may also be improved.

In some embodiments, the battery is a Li-ion battery. In some embodiments, the battery is a Li-ion battery and the electrolyte comprises LiPF₆.

### 4. Examples

### Example 1

### Self-Healing Liquid Metal Material Systems

### Materials & Methods

Preparation of the LM Nanoparticle (LMNP):

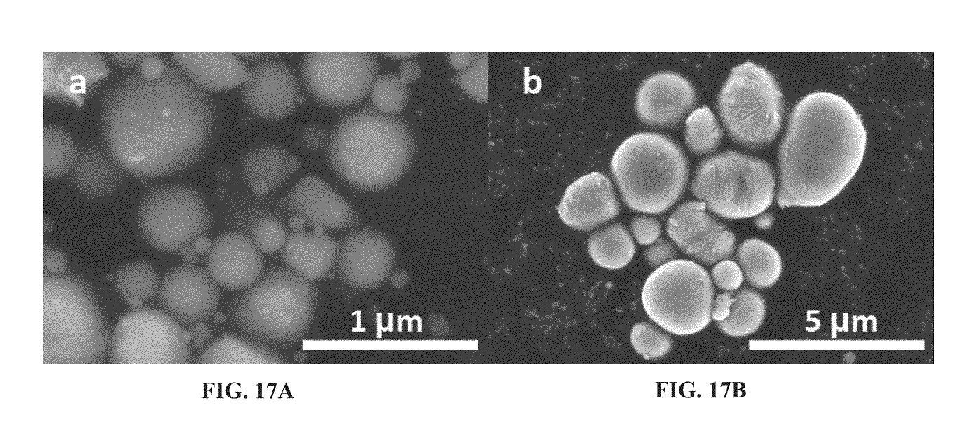

The Ga—Sn LM alloy was simply prepared by a combination of melting and sonication. Ga and Sn were physically mixed (88:12 by weight) and melted at 300° C. with mild stirring for 2 h while protected by Ar. The LM alloy was obtained after cooling down to RT. Then, 0.18 g LM alloy was dropped into a beaker and 0.75 mL 1ATC9 (3-mercapto-N-nonylpropionamide) ethanol solution (1 mM) was added. The 1ATC9 was used as a surfactant to reduce the size of the LM particles during the sonication. In brief, when the bulk LM was subjected to the sonication, large LM particles were broken into small ones, whose surfaces would attract the 1ATC9 because of the interaction between the LM and thiol groups in the 1ATC9. The 1ATC9 as a surfactant thus helped prevent small LM particles from re-assembling into large particles. Probe ultrasonication was used to break the large LM droplets into smaller ones. Every 2 min sonication was followed by a 10 min break to avoid the overly high temperature (under 50° C.), which was repeated 15 times. The resulting dispersion was settled for 3 h to precipitate the larger LM particles (most were larger than 1 μm in diameter) and then the upper suspension was collected. The suspension was dried under 50° C., and LMNPs were collected. FIG. 17A and FIG. 17B clearly show that the as-prepared LM particles with 1ATC9 (FIG. 17A) are much smaller than those without 1ATC9 (FIG. 17B).

Preparation of the Carbon Skeleton-Supported LMNP:

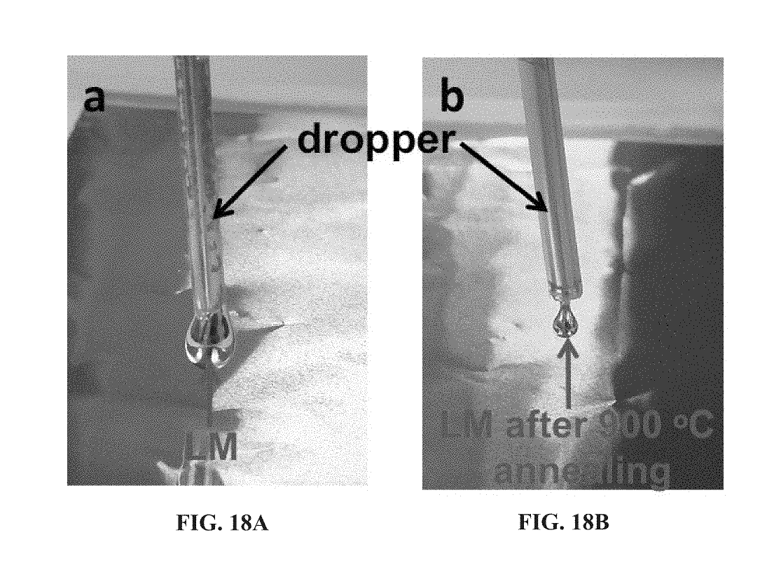

First, 60 mg LMNP was added to 0.5 mL ethanol (200 proof) with 12 mg CNTs, and then sonicated for 30 min to make a uniform suspension. To obtain better dispersibility and to remove the amorphous carbon and the catalyst, the original CNTs were refluxed in 2.6 M nitric acid for 24 h and then washed with deionized water and dried. Then, 4 mg GO gel (2 wt. % in ethanol, in gel state) was added to the suspension, followed by sonication for 5 min and shaking for 2 min, producing a gel-like composite. A solvothermal process was applied at 160° C. for 6 h in a well-sealed high-pressure tank. The produced LMNP composite was dried and annealed at 900° C. for 4 h. Materials for control experiments without CNTs were produced using the same protocol without the addition of CNTs. The Ga—Sn alloys were reported stable up to 1,226° C. To confirm the stability of our LM, the LM was heated to 900° C. for 4 h and cooled down to the R.T. The as-annealed LM was still in the liquid state like before annealing (FIG. 18A and FIG. 18B). Further EDS analysis suggested the same Ga/Sn ratios before and after 900° C. annealing.

Preparation of the Electrode:

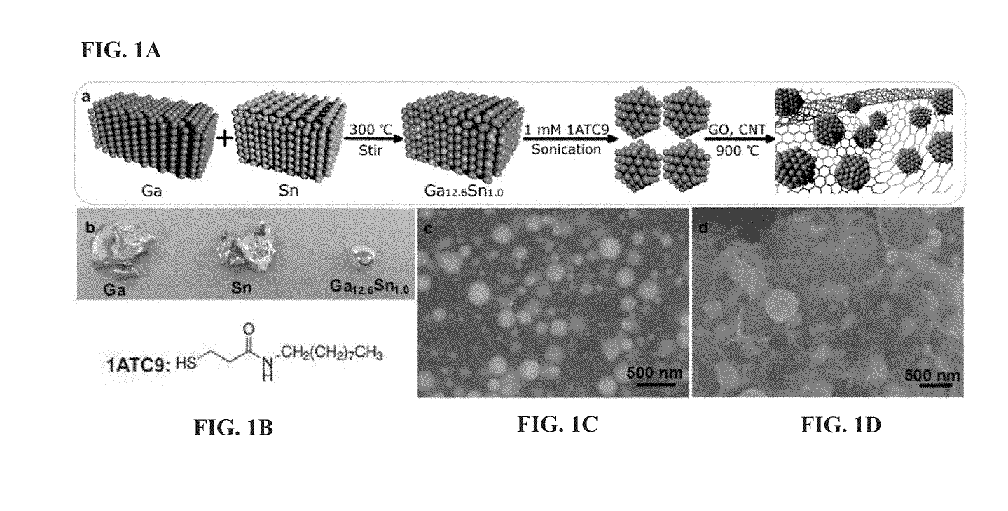

In order not to destroy the LMNP, the carbon-skeleton supported LMNP was milled into powder in liquid nitrogen. The powder was dried in a vacuum oven at 40° C. for 2 h to remove the moisture caused by the low temperature. Slurry was made by mixing the powder with carbon black as a conductive additive, CMC, and SBR as a binder, at the ratio of 20:2:1:1 by weight using a mixer (Benchmark Scientific Mortexer BV1005). The slurry was uniformly pasted on Cu foil substrates (1.26 cm in diameter) using a blade to reach a mass loading of 0.5-1 mg/cm². These prepared electrodes were dried at 60° C. in a vacuum oven for more than 3 h. Electrodes for control experiments were made using RGO or CNTs separately with the same protocol. In the whole process, there was no further fracture of the LMNPs, as evidenced by the SEM images in FIG. 1C and FIG. 1D which show that there was no obvious change in the size of LMNPs.

Electrochemical Characterization:

The charge/discharge performance was characterized by using 2032-type coin cells that were assembled in an Ar-filled glove box with oxygen and moisture contents below 1 ppm, LM as a working electrode, and lithium metal as a counter electrode. 1 M LiPF₆ dissolved in ethylene carbonate/ethyl methyl carbonate (40:60, v/v) was employed as the electrolyte, with 5 wt. % fluoroethylene carbonate and 1 wt. % vinylene carbonate as additives.

The coin cells were tested on a LAND battery tester with a cutoff voltage ranging between 0.01 and 2.5 V. Cyclic voltammetry (CV) and electrochemical impedance spectroscopy (EIS) of the as-prepared electrodes were measured on a PARSTAT 4000 electrochemical station using a three-electrode cell. The LMNP electrode worked as a working electrode, with a lithium disk as a counter electrode and a lithium ring as a reference electrode. The CV was carried out at a scanning rate of 0.05 mV/s while the EIS was tested between 10,000-0.1 Hz with an amplitude of 10 mV. The EIS measurements were performed at 2.5 V and 0.01 V at each cycle.

For the in-situ galvanostatic charge/discharge test by microscope, a cuvette cell with random orientation quartz windows was used to make the transparent battery. A thin layer of LM was pasted on the Cu foil as a working electrode and a lithium foil was riveted on the Cu foil as a counter electrode. The transparent battery was assembled in the glove box and sealed with a plastic cap and vacuum grease.

Vibration Test:

The vibration test for the carbon skeleton-supported LMNP material was performed at an acceleration of 26 Gs for 1 min at 60 Hz.

Other Characterization:

As-prepared samples were characterized using a Hitachi (S-4800) scanning electron microscope (SEM) equipped with a Bruker Quantax energy dispersive X-ray spectroscopy (EDS) system, operated at a 10 kV acceleration voltage.

### Results & Discussion

The Self-Healing Ability of the LM Alloy:

Both Ga and Sn have a high theoretical capacity (769 and 990 mAh/g, respectively) and the calculated theoretical capacity of the Ga—Sn LM alloy is 795 mAh/g, more than twice that of the traditional graphite anode. The melting point of our Ga—Sn LM alloy (Ga:Sn=88:12 by weight) is 20° C., which is lower than those of Ga and Sn and below the typical RT (25° C.). In addition, the LM alloy is capable of super-cooling below its melting point to −6° C. In other words, the LM alloy can remain as a liquid at temperatures typically found in applications for which LIBs are mostly used. FIG. 1B shows the Ga and Sn in solid state and the LM alloy in liquid state at RT.

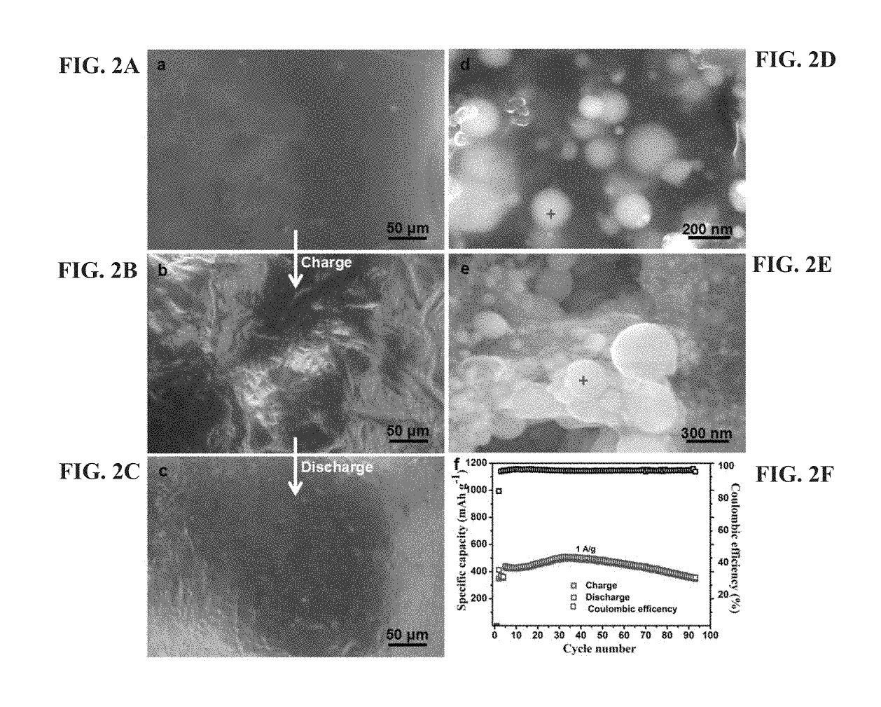

The self-healing ability of the LM alloy was examined by in-situ microscopy during the charge/discharge process using a homemade transparent LIB, with the thin LM layer as the working electrode. As shown in FIG. 2A, before charging, the surface of the LM was smooth and had some glittering due to the reflecting light. During the charging process, the glittering faded gradually and the smooth surface became rougher. At the full lithiation state, the LM alloy became a solid state with a notable increase in surface roughness with bumps and ravines (FIG. 2B). This rough surface was caused by volume expansion during the lithiation, as the volume expansion for Ga and Sn is 160% and 260%, respectively. During the subsequent delithiation process, the bumps and ravines disappeared and the surface became smooth again (FIG. 2C). No cracking was observed, which is attributed to the self-healing property of the liquid state. Such self-healing behavior avoided the expansion/contraction-causing crack formation, detachment of active materials from the current collector, and breakdown of the electronically conductive network.

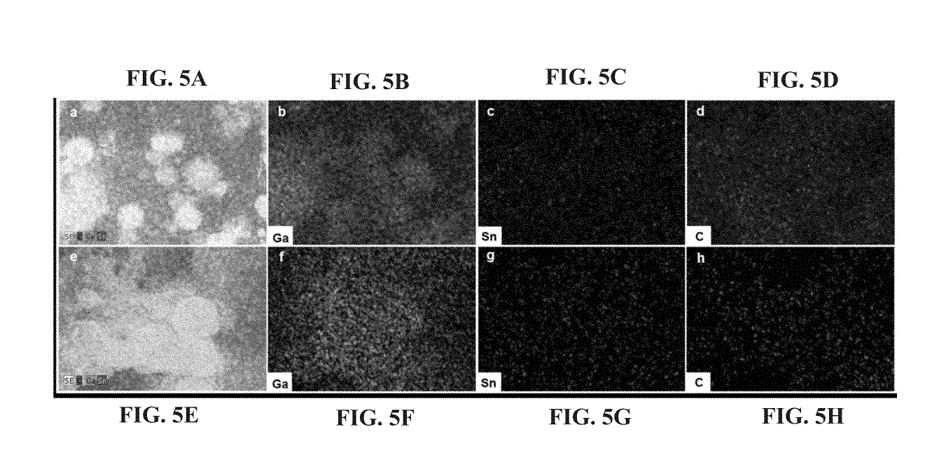

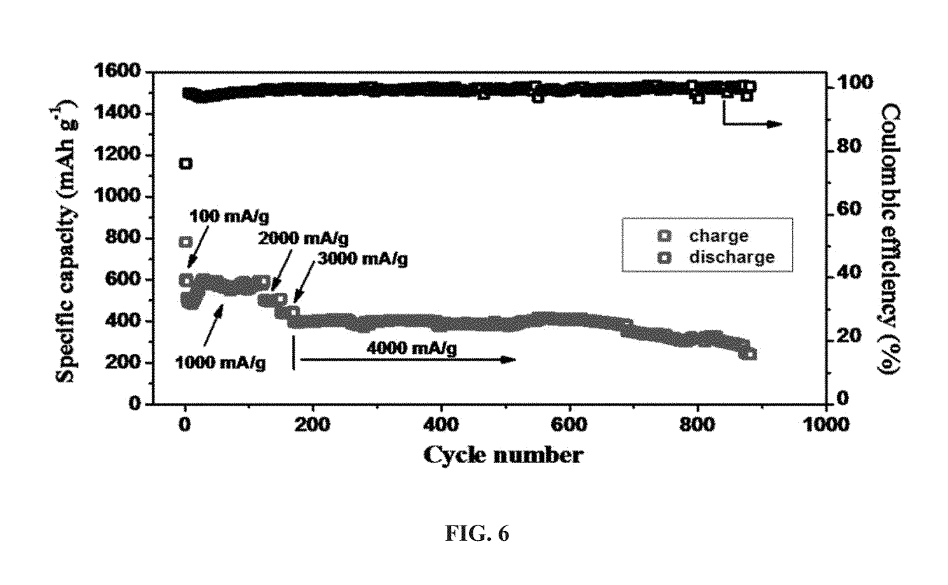

In a further step, ex-situ scanning electron microscopy (SEM) and energy-dispersive X-ray spectroscopy (EDS) were used to demonstrate the self-healing behavior. Liquid metal nanoparticles (LMNPs) were used as the working electrode and coin cells were assembled. FIG. 1C shows the as-prepared LMNPs, with sizes ranging mainly between 50˜500 nm. The high surface energy of the LM drove it to a spherical shape. The morphology of the LMNPs stayed the same as the nanospheres before and after the cycles, with no obvious size change (FIG. 2D and FIG. 2E). The EDS of the entire region (FIG. 5A-FIG. 5H) showed no constituent change of the electrode after the cycles. The EDS at especially marked points (the red cross points in FIG. 2D and FIG. 2E) on the LMNPs showed the same invariable constituent results. In FIG. 2D, before cycling, the Ga:Sn in the entire region was 87:13 by weight and 88:12 for the red cross point. After cycling (FIG. 2E), the Ga: Sn in the entire region was 85:15 by weight and 86:14 for the red cross point. Given the accuracy of the EDS, the Ga:Sn is considered as constant before and after cycles. The above results directly support the self-healing ability of the LM and LMNP.

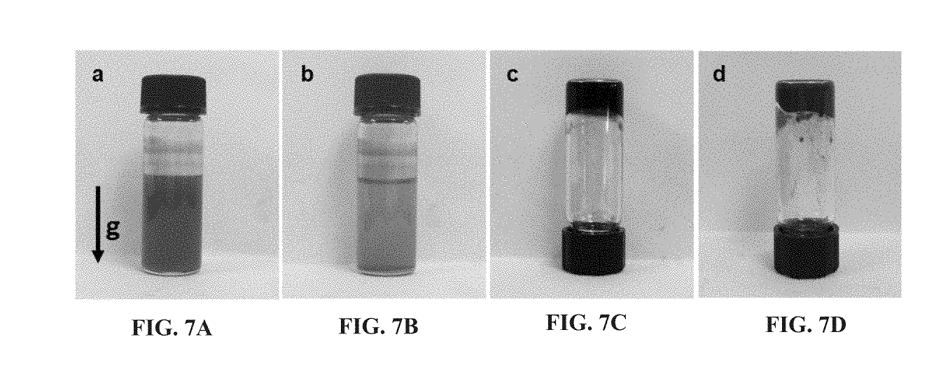

Although the LMNP anode showed a self-healing property, the expansion of the LMNP during the lithiation/delithiation still caused the binder to crack and change the morphology (FIG. 2D and FIG. 2E), because the binder (sodium carboxymethyl cellulose (CMC) and styrene butadiene rubber (SBR)) is not a self-healing material. The cracks peeled the binder from the current collector and the LMNP lost the connection with it, causing capacity fading during the cycles (FIG. 2F). To address this issue, GO and CNTs were used to rivet the LMNP into a 3D structure (FIG. 1A and FIG. 1D). The 1D and flexible CNTs not only worked as the conductive network, but also as the buffer during the expansion/contraction of the LMNP. Control experiments without CNTs showed the cycle life was less than 900 cycles (FIG. 6). The GO here was used as a thickener and stabilizer. FIG. 7A-FIG. 7D shows sonicated LMNPs suspension precipitated after 24 h by the gravity. Using the gel-like GO as the thickener and stabilizer, there was no precipitation of the LMNPs after 24 h and the LMNPs were homogeneous in the system.

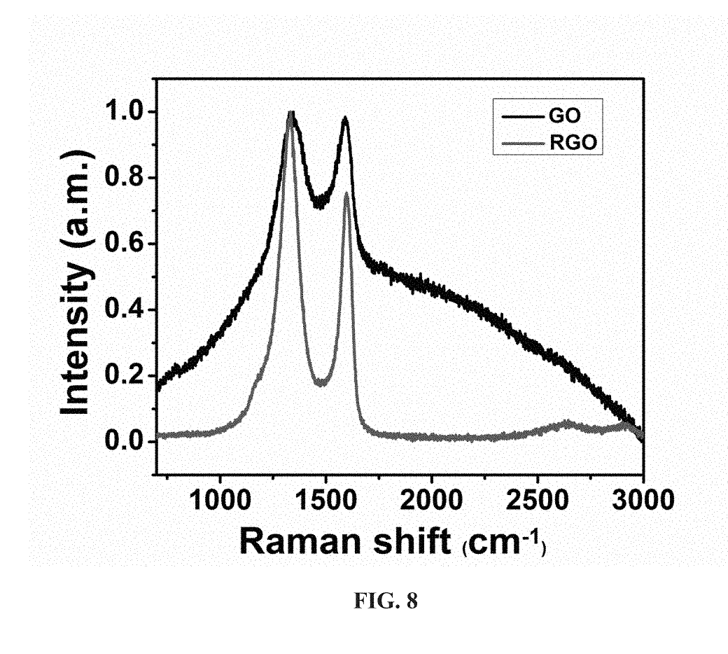

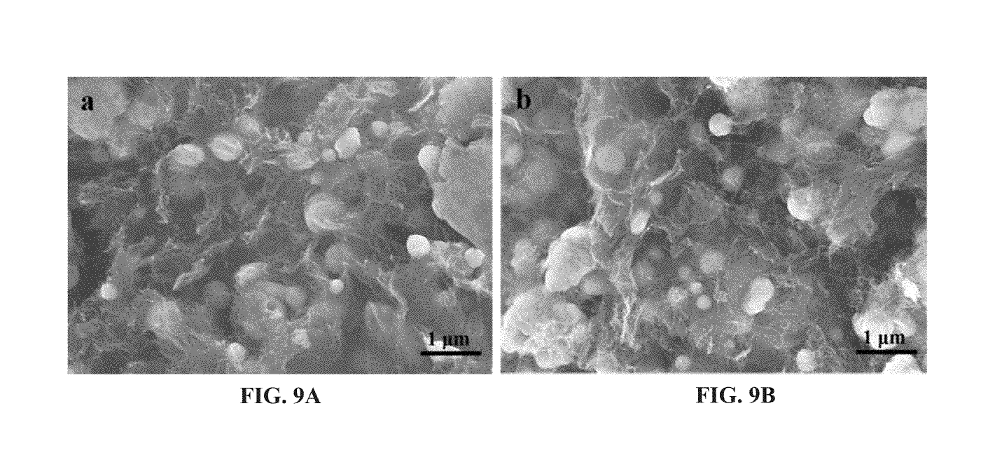

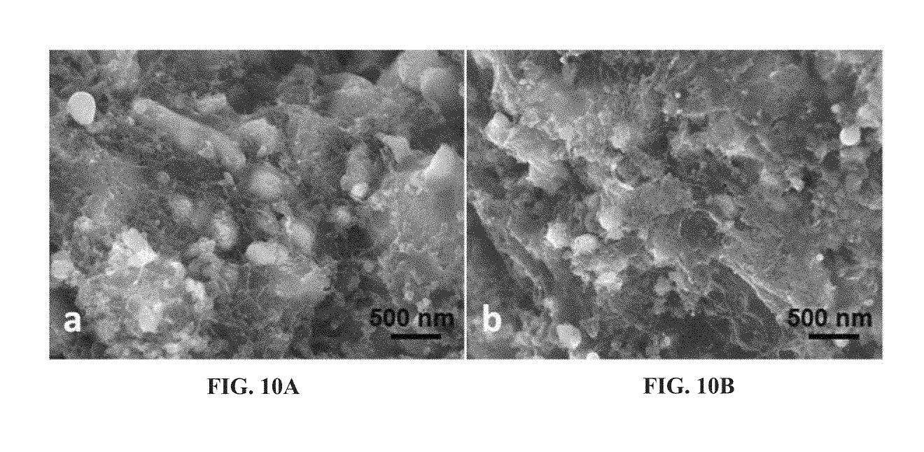

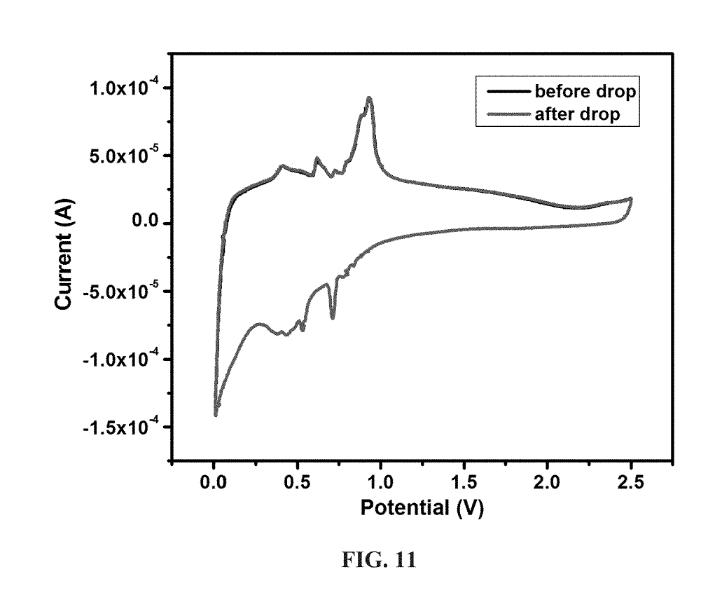

In a subsequent step, the thermal annealing process turned GO to RGO, as shown in the Raman spectra (FIG. 8), and the structure and conductivity of GO were partially recovered. FIG. 1D depicts the LMNPs embedded in the carbon skeleton forming a 3D structure. Such a structure not only fixes the LMNPs, but also offers a better ion diffusion pathway and makes full use of the Li-active material, thereby leading to a better rate capability. The vibration test showed the LMNPs embedded in the carbon skeleton were well protected by the coated carbon. There was no change in the size or the shape of the LMNPs (FIG. 9A and FIG. 9B) before and after the vibration. The effect of external pressure such as dropping was also studied, which again suggested the high stability of the anode material (FIG. 10 and FIG. 11). In particular, we did the dropping test of the battery. We dropped the battery at 2-m high onto a hard floor for over 50 times. The SEM images (FIG. 10A and FIG. 10B) suggested there was no change of the morphology before (a) and after (b) dropping. And the electrochemical performance of the anode material was stable after dropping. The CV curves (FIG. 11) before and after dropping were overlapping, indicating high stability of the anode. With such carbon skeleton, the LMNPs were prevented from directly contacting the Cu current collectors, which avoided the potential possibility of alloy formation with Cu.

The Electrochemical Performance and Structure Analysis of the 3D LMNP Anode:

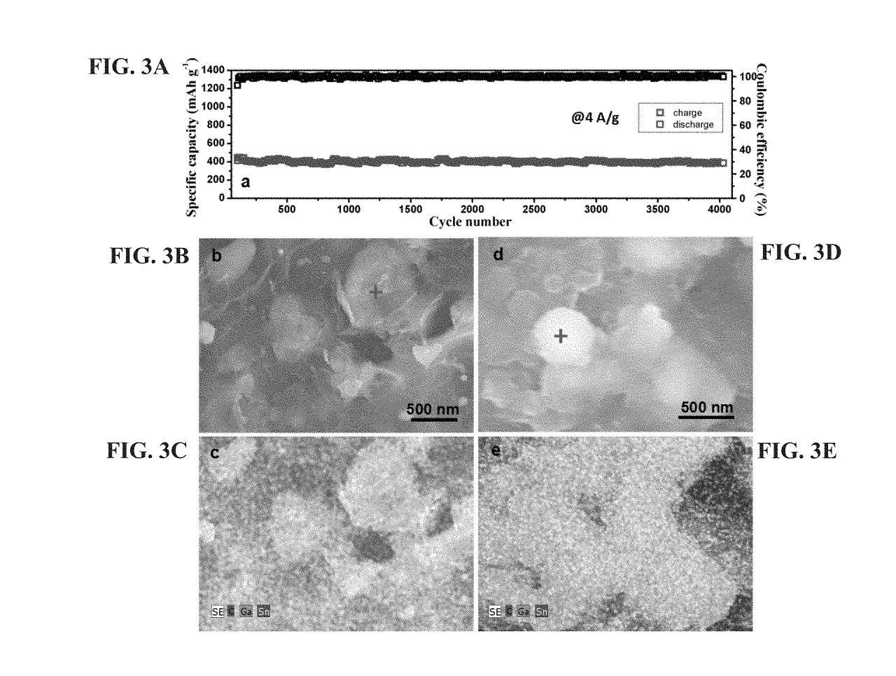

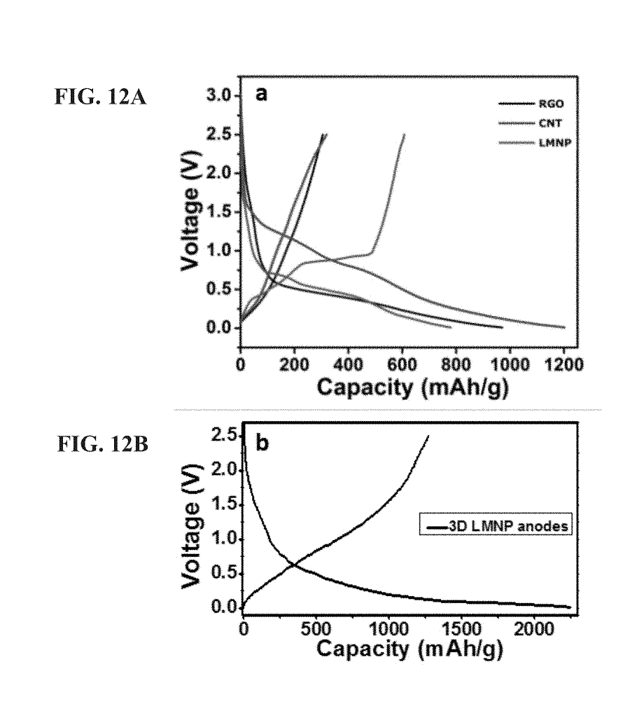

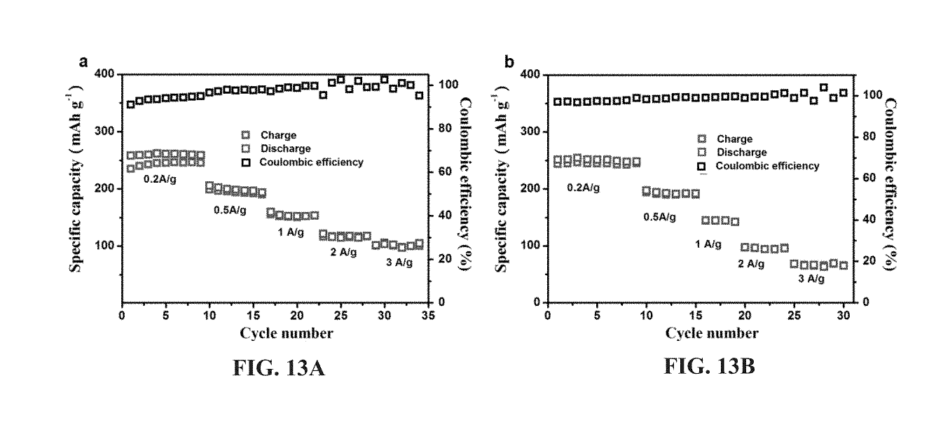

The electrochemical performance of the 3D LMNP anode was evaluated using galvanostatic discharge-charge measurements (FIG. 3A). The initial discharge (delithiation) capacity at 200 mA/g was approximately 1,000 mAh/g with an initial Coulombic efficiency (C.E.) less than 60%. The irreversible capacity loss was likely associated with the formation of the solid-electrolyte interphase (SEI) layer and the reduction of remaining oxygen-containing functional groups on the RGO and CNTs. Control experiments showed the RGO and CNTs were the main contributors of the irreversible capacity (FIG. 12A). For RGO, the C.E. of the first cycle was 31% and for CNTs it was 26%, in contrast to ˜80% of the pure LMNPs (FIG. 12B). After activation for the initial three cycles at 200 mA/g, the LMNP anode was cycled at different rates for the rate test and then at a higher rate (4,000 mA/g) for the cycling test. The high reversible capacity still remained at ˜400 mAh/g with a C.E. more than 99.5% after 4,000 cycles—this is the longest cycle life reported for any metal anode material. Table 2 shows a comparison of the cyclic performance between the previous reports and our work, demonstrating the much better cyclic performance of our LMNP anode. The superior cyclic performance is attributed to the self-healing ability of our anode; in contrast, those Sn-M (M=Ge, Cu, Mg, Fe) alloys/composites did not exhibit such extraordinary cyclic performance. For example, while a Ge—Sn alloy delivered a higher capacity due to the higher theoretical capacity of Ge, our Ga—Sn alloy exhibited much superior cyclic performance (4,000 vs. 1,700 cycles). Control experiments showed that RGO and CNTs contributed very little to the reversible capacity (FIG. 13A and FIG. 13B). Considering the relatively low capacity and the low percentage of the additive in the entire anode, most of the capacity was from the LMNP.

TABLE 2
Comparison of anode performance between
literature and the current work.

| | Cycle | | |
|---|---|---|---|
| Anode | life | Capacity | Characteristic |
| Si | 1,300 | Fixed to 1,200 | Alginate binder |
| | | mAh/g at 1.2 A/g | |
| Si | 2,000 | 1,000 mAh/g | Silicon nanowire |
| | | at 4 A/g | |
| Sn | 1,000 | 652 mAh/g at | Graphene networks anchored Sn |
| | | 2 A/g | nanoparticles |
| Sn | 1,000 | 537 mAh/g at | CNTs/carbon cubes networks |
| | | 3 A/g | anchored Sn nanoparticles |
| Ga | 30 | ~400 mAh/g, | Working at 40° C. |
| | | C/20 charging, | |
| | | C/5 discharging | |
| Ga | 100 | 400 mAh/g at | Working at 55° C., Ga nano- |
| | | 0.1 A/g | particles were embedded in carbon |
| | | | network |
| Ge—Sn | 1,700 | 890 mAh/g at | Ge—Sn composite |
| | | 3 A/g | |
| Ge | 1,200 | 1,080 mAh/g | Crumpled N-doped carbon nano- |
| | | at 0.5 C | tubes encapsulated with Ge |
| | | | nanoparticles |
| Sb | 100 | 488 mAh/g at | Rod-like Sb—C composite |
| | | 0.1 A/g | |
| Sn—M | 20 | 227 mAh/g at | Sn—M (M = Cu, Mg and Fe) |
| | | 0.1 A/g | intermetallic alloys |
| | | (Sn—Fe) | |
| Si with | 100 | ~800 mAh/g | Self-healing polymer as binder |
| carbon | | at 0.1 A/g | |
| Si | 130 | ~2,000 mAh/g | Self-healing polymer as binder |
| | | at 0.1 C | |
| This | >4,000 | 780 mAh/g at | Self-healing LM anode working at |
| work | | 0.1 A/g, ~400 | RT |
| | | mAh/g at 4 A/g | |
| | | after 4,000 | |
| | | cycles | |

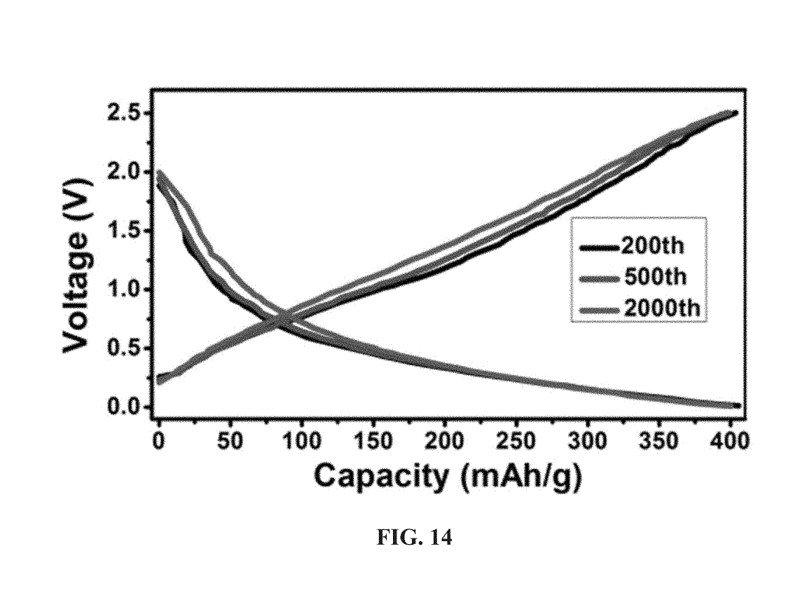

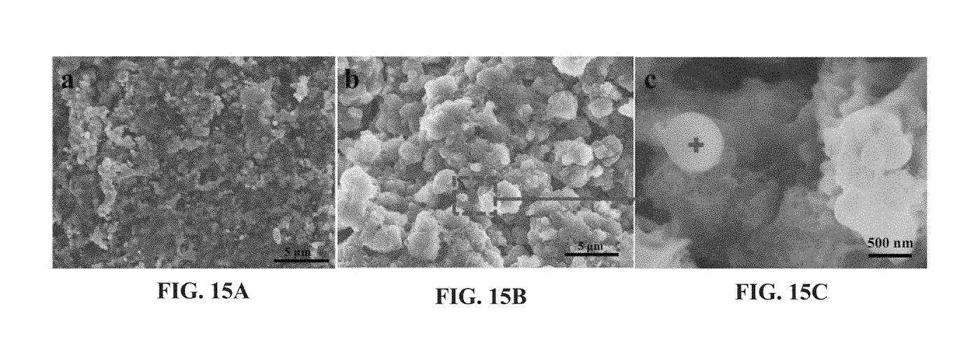

The excellent cyclic performance of such a 3D LMNP is attributed to the self-healing behavior of liquid, as shown in the first part of this Example (FIG. 2). The voltage profiles of the different cycles are shown in FIG. 14; very little change in the charge/discharge profile can be found after thousands of cycles, indicating superior and stable cycling performance. FIG. 3B-FIG. 3E shows the SEM and EDS data of the 3D LMNP electrode before and after 300 cycles. The morphology of the electrode showed no obvious changes: the LMNP kept the spherical shape and the size, anchored in the 3D network of CNTs and RGO. The EDS tests showed no constituent change of Ga and Sn before and after cycles, and the Sn—Ga ratio remained the same as the designed ratio. For FIG. 3B, before cycling, Ga:Sn in the entire region was 86:14 by weight and 88:12 for the red cross point. After cycling (FIG. 3D), the Ga:Sn in the entire region was 87:13 by weight and 88:12 for the red cross point. These results indicate there was no composition change after cycles. After ˜4,500 cycles, the LMNPs still kept the spherical shape and the size (FIG. 15C), and there was no composition change (the Ga: Sn at the red cross point was 88:12 by EDS test). However, with a self-healing anode, the capacity of the battery still decayed after long cycles because of the crack formation in the binder. The SEM imaging showed that the flat surface of the anode before the cycles (FIG. 15A) turned into deep trenches across the entire anode (FIG. 15B), which was caused by the expansion of the LMNP during the lithiation/delithiation.

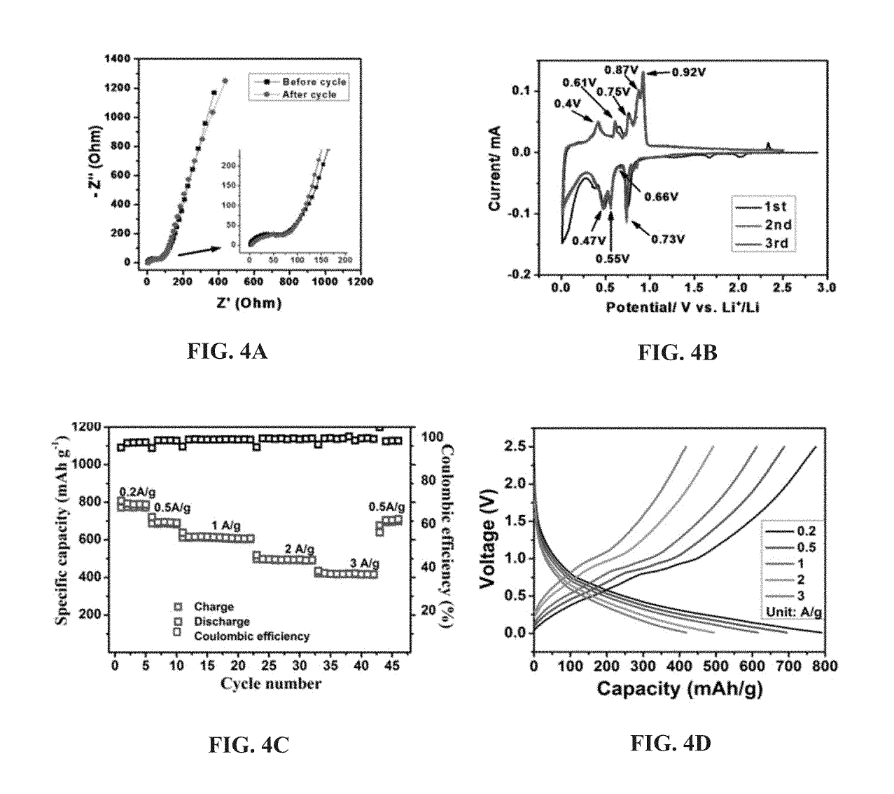

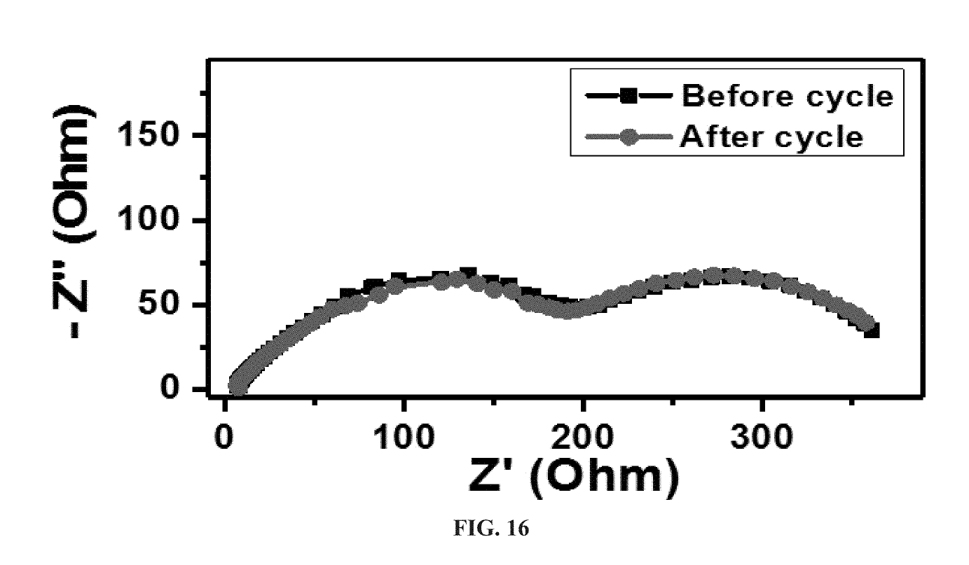

FIG. 4A shows the Nyquist plots of the LMNP electrode at the fully discharged state before and after a galvanostatic discharge-charge cycle. The two Nyquist plots almost overlap, implying there was no resistance change of the SEI layer, charge transfer, and lithium ion diffusion, and thus the full self-healing recovery of the LMNP anode. At the fully charged state (FIG. 16), the Nyquist plots still overlap, showing the same results as the fully discharged state, thereby proving the effective self-healing property of the anode.

The cyclic voltammetry (CV) test was performed to further characterize the electrochemical performance of the LMNP electrode at a scan rate of 0.05 mV/s in a voltage range of 0.01-2.5 V (versus Li⁺/Li). During the first cathodic scan, the irreversible peak at about 1.2 V was associated with the SEI layer formation, and the other peaks were associated with the reduction of oxygen groups and other irreversible side reactions. In the subsequent cycles, redox reactions of lithium insertion/extraction are highly reversible, confirming an excellent cyclic performance. The cathodic lithium insertion mainly occurs at 0.47 and 0.66 V for the Sn and at 0.55 and 0.73 V for the Ga; the anodic lithium extraction occurs at 0.61 and 0.87 V for the Sn and at 0.4, 0.75, and 0.92 V for the Ga. All these results agree well with the literature. After activation of the first scan, the well-overlapping peaks in the subsequent CV curves confirmed the excellent cyclic performance of the LMNP, thus benefiting from the self-healing property (FIG. 4B).

FIG. 4C and FIG. 4D show the rate capability of the 3D LMNP anode. The capacities at 200, 500, 1,000, 2,000, and 3,000 mA/g are 775, 690, 613, 493, and 417 mAh/g, respectively, manifesting an exceptionally high rate capability. After the 3,000 mA/g test, the capacity at 500 mA/g went back to 704 mAh/g, suggesting a total recovery. Such a high rate capability can be attributed to our rationally designed 3D porous architecture of the self-healing LM combined with the geometric confinement effect. Due to the self-healing property, there was no cracking or pulverization of the LMNPs when the electrode experienced the high charge/discharge rate, and the capacity experienced a full recovery when returning to the relatively lower charge/discharge rate.

The morphology of the anode is also important for electrochemical performance. In the reported literature, Ga film was pasted on the current collector. Considering the fluidity of liquid, the Ga anode of such a structure is likely to flow down from the current collector and thus lead to inferior cycle performance (fewer than 30 stable cycles). Previous research has improved the structure of the anode. The Ga anode was confined in a thick carbon matrix and the cycle performance improved (nearly 100 stable cycles); however, the electrochemical performance is still not good enough (<500 mAh/g at 0.1 A/g) because the carbon content is too high (more than 70 wt. %). Such a high carbon content brings down the average capacity of the Ga/carbon anode, and the thick carbon coating blocked the electronic and ionic transfer pathways, which lowered the rate performance.

In addition to the significantly advantageous RT operation (compared with the operating temperature of 35° C. or higher for previous liquid metal electrodes), our new LM electrode primarily contains LM and the added RGO/CNTs was less than 20 wt. %, much lower than that reported in the literature (70 wt. %). In addition, the RGO/CNTs formed an elastic and stable shell for the LMNPs, offering a good encapsulation, which accommodated the volume change of LMNPs during the electrochemical cycling. The 3D carbon frameworks with porous features and high surface area provided efficient electronic and ionic transfer pathways, contributing to the much-improved reversible capacity and rate capability.

In summary, a novel room-temperature liquid metal was demonstrated as the anode for the LIB. This liquid metal anode showed a self-healing property, benefiting from the fluidity and the surface tension of the liquid. The self-healing property avoided the expansion/contraction-induced cracking of the Li-active material during cycling and led to excellent cyclic performance. There was no obvious decay in capacity over 4,000 cycles with a capacity of ˜400 mAh/g at 4,000 mA/g, which represents the best cycle performance for all metal anodes reported thus far. Besides the ultra-long cycle life, the anode also delivered a high capacity of 775, 690 and 613 mAh/g at the rate of 200, 500, and 1,000 mA/g, respectively. Moreover, the self-healing mechanism was examined by in-situ and ex-situ tests during the cycles. This work offers a new path toward achieving a long cycle life for LIBs, and one step further, will be useful for flexible electronic devices, self-healing electronic circuits, or other applications that suffer from mechanical issues during electrochemical reactions, e.g., fuel cells, water splitting, and catalysis.

### Example 2

### Self-Healing Liquid Metal/Silicon Composite Materials

### Materials & Methods

Preparation of the Si and LM Composite (SLC):

The preparation of the LM nanoparticle (LMNP) was done as described in Example 1. To obtain a better wetting ability, the Si nanoparticle (crystalline, 99%, plasma-synthesized, Alfa Aesar) was modified by hydroxyl using the Piraha method. Next, 100 mg modified Si nanoparticles and 200 mg LMNPs were added to the ethanol and then sonicated in an open jar, leaving the ethanol to evaporate. The temperature was controlled under 50° C. After the ethanol evaporated, the residue was scraped down and ground into powder in the liquid nitrogen. The powder was placed into the ethanol again and the sonication process was repeated until the ethanol evaporated completely (five times). The last residue was scraped down and ground into powder in the liquid nitrogen for further use. The composites with different Si/LM ratios were prepared with the same protocol. The Si/LM weight ratio is 2:1 for SLC_{2V1} and 1:1 for SLC_{1V1}. The composition of the control Si sample is the same treatment as the SLC sample but without the addition of the LM.

Preparation of the Carbon Skeleton-Supported SLC:

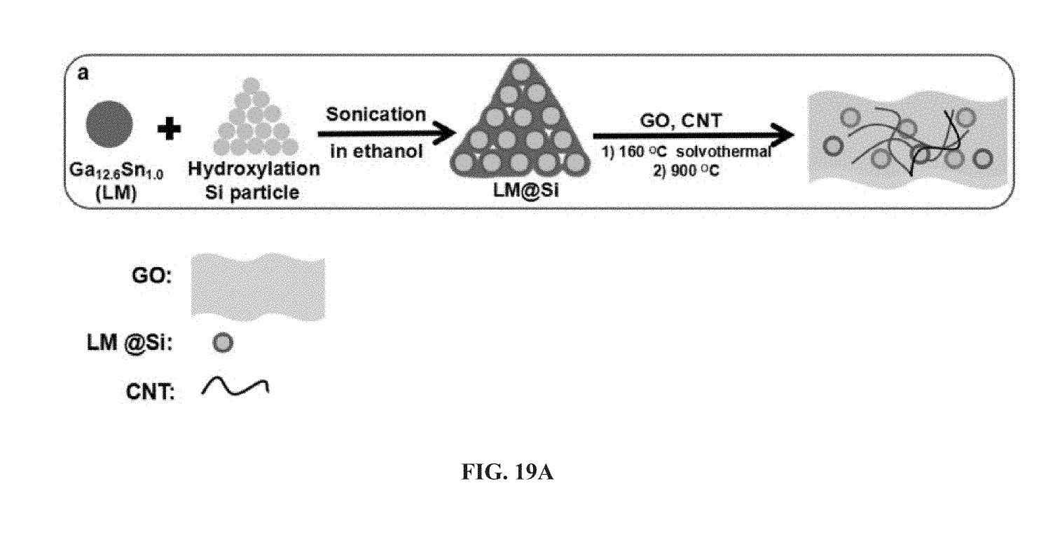

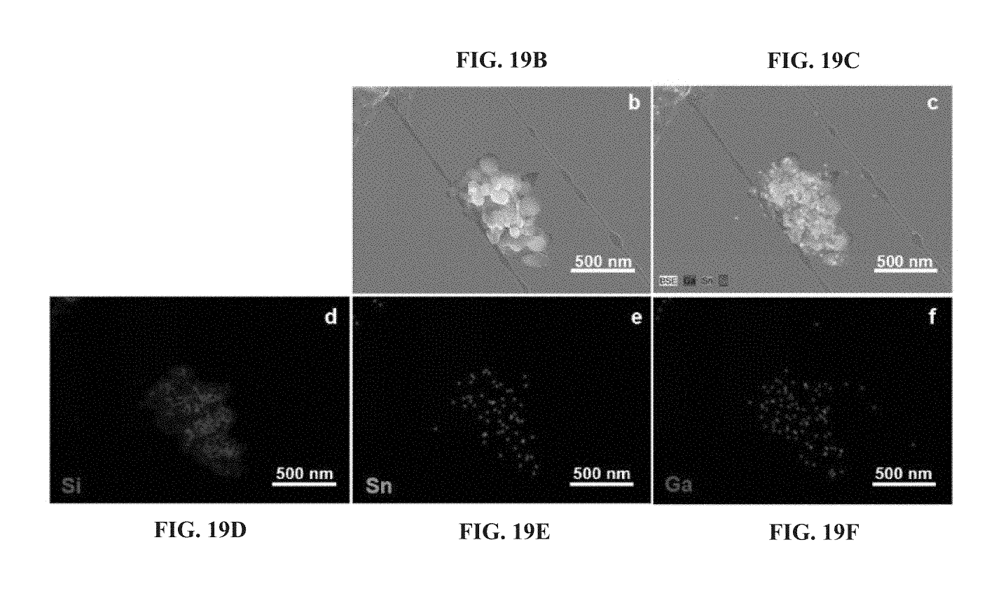

First, 60 mg SLC was added to 0.5 mL ethanol (200 proof) with 12 mg CNTs, and then sonicated for 30 min to produce a uniform suspension. The CNTs were treated with nitric acid before use. Then, 4 mg GO gel (2 wt. % in ethanol, in gel state) was added to the suspension, followed by the sonication for 5 min and shaking for 2 min, producing a gel-like composite. A solvothermal process was applied at 160° C. for 6 h. The produced SLC composite was dried and annealed at 900° C. for 4 h. (FIG. 19A-FIG. 19F)

Preparation of the Electrode:

The electrode was prepared using the same protocol as described elsewhere. The mass loading was 0.5-1 mg/cm². Electrodes for the control experiments were fabricated with the same protocol without LM or with different Si/LM ratios.

Electrochemical Characterization:

The electrochemical characterization was performed using the same protocol as described in Example 1. The charge/discharge performance was characterized by using 2032-type coin cells. Then, 1 M LiPF₆ dissolved in ethylene carbonate/ethyl methyl carbonate (40:60, v/v) was employed as the electrolyte, with 5 wt. % fluoroethylene carbonate and 1 wt. % vinylene carbonate as additives.

The coin cells were tested on a LAND battery tester with a cutoff voltage ranging between 0.01 and 2.5 V. Cyclic voltammetry (CV) was measured on a PARSTAT 4000 electrochemical station using a three-electrode cell. The CV was carried out at a scanning rate of 0.05 mV/s.

### Results & Discussion

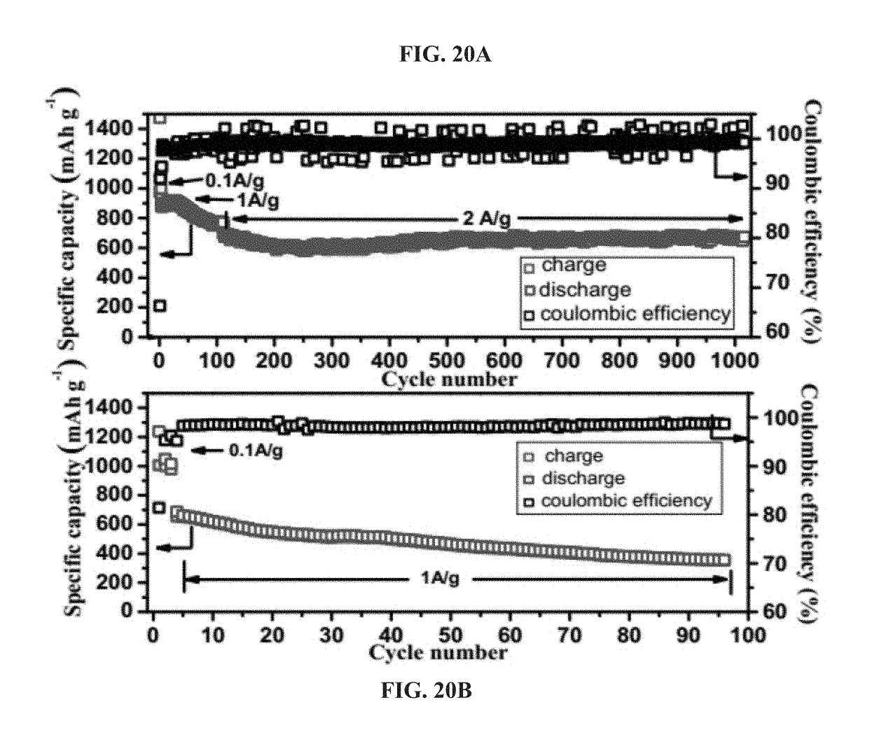

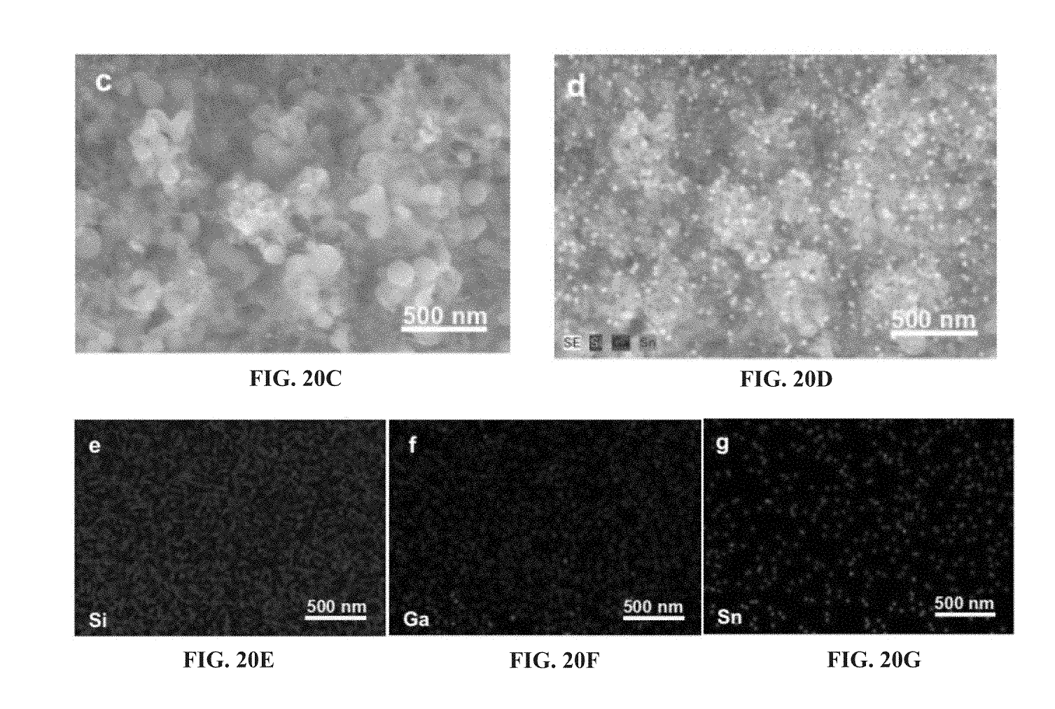

The SLC was fabricated by sonication and milling. Synthesis of the SLC is illustrated in FIG. 1A. The Si/LM ratio is 1:2 by weight. The one-dimensional and flexible carbon nanotubes (CNTs) acted as the conductive network and the bandage, while the graphene oxide (GO) was used as a thickener and stabilizer. A scanning electron microscopy (SEM) image shows a porous structure formed during the solvothermal process (FIG. 20C). Benefited from the high wetting ability of the Ga, the LM and Si nanoparticles were homogeneously dispersed in the whole material, as shown by the energy dispersive X-ray spectroscopy (EDS) results (FIG. 20D-FIG. 20G). FIG. 19B-FIG. 19F show the SEM and EDS results for the SLC composite. The Si nanoparticles with sizes of ˜100 nm embedded in the carbon/LM skeleton formed a 3D structure. The EDS elemental mapping shows that the LM was homogeneously dispersed and the Ga:Sn ratio was 88:12, the same as the designed LM composition.

Benefited from its liquid state and self-healing ability, the LM can be a good buffer for the volume change of Si. During the charging process, the Si expanded and pushed the surrounding LM away and occupied its space. The LM flowed away and was forced into the void spaces formed by the solvothermal process. This process avoided the expansion/contraction-causing crack formation, thereby preventing the active materials from detaching from the current collector and maintaining the electronically conductive network. Such protection from the LM leads to enhanced cycle life (FIG. 20A and FIG. 20B).

In the past several years many efforts have been made to buffer the volume change in Si anodes. In addition to using a self-healing polymer, another approach is to use material with elasticity and robustness such as graphene, carbon nanotubes, or other allotropes of carbon. Compared with these materials, there are several advantages to using the LM buffer: (1) the self-healing ability of LM offers a long-life buffer in the anode system; (2) the liquid state can easily change its shape to buffer the stress caused by the volume expansion/contraction of Si without breaking the main structure of the anode; (3) the metallicity of LM can offer better conductivity than self-healing polymers or carbon materials; and (4) LM offers a relatively higher theoretical capacity than carbon materials.

FIG. 20A depicts the cyclic performance of the SLC anode, which was evaluated using galvanostatic discharge-charge measurements. The initial discharge (delithiation) capacity at 100 mA/g was ˜1,400 mAh/g with an initial Coulombic efficiency (C.E.) ˜66%. The irreversible capacity loss was likely caused by the formation of the solid-electrolyte interphase (SEI) layer and the reduction of remaining oxygen-containing functional groups on the RGO and CNTs.

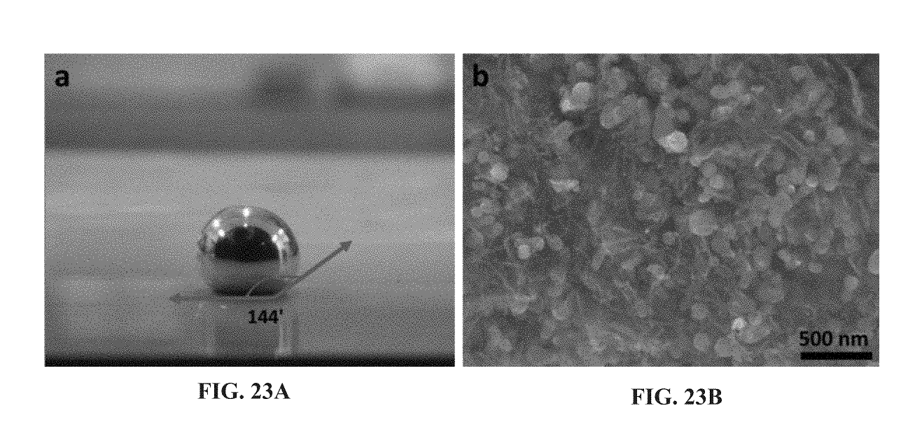

After activation for three cycles at 100 mA/g, the SLC anode was cycled at 1,000 mA/g and then at 2,000 mA/g for the cycling test. Benefited from the high capacity of Si, the capacity of the SLC is much higher than that of the reported LM anode at the same current rates. At the same time, protected by the LM, the SLC electrode showed excellent cyclic performance. FIG. 20A shows that the high reversible capacity remained at ˜670 mAh/g with a C.E. more than 99.3% after 1,000 cycles. Although the LM was in the liquid state, no short-circuit occurred due to our precautions. We used the separator consisting of a trilayer porous polymers (polypropylene/polyethylene/polypropylene), which helps block particles travelling to the counter electrode. Meanwhile, a poor wettability of the LM on the separator was observed with a contact angle of 144° (FIG. 23A). More importantly, we used CNT and graphene oxide as the skeleton to prevent the Si and LM from travelling and aggregating (FIG. 23B). A control experiment without the LM was done with the same conditions. Without the protection of the LM, the volume expansion/contraction during lithiation and delithiation reactions resulted in crack formation, thereby deactivating the Li⁺ storage ability and leading to inferior cycle performance. The capacity of the LM-free electrode dropped quickly to ˜370 mAh/g after 100 cycles.

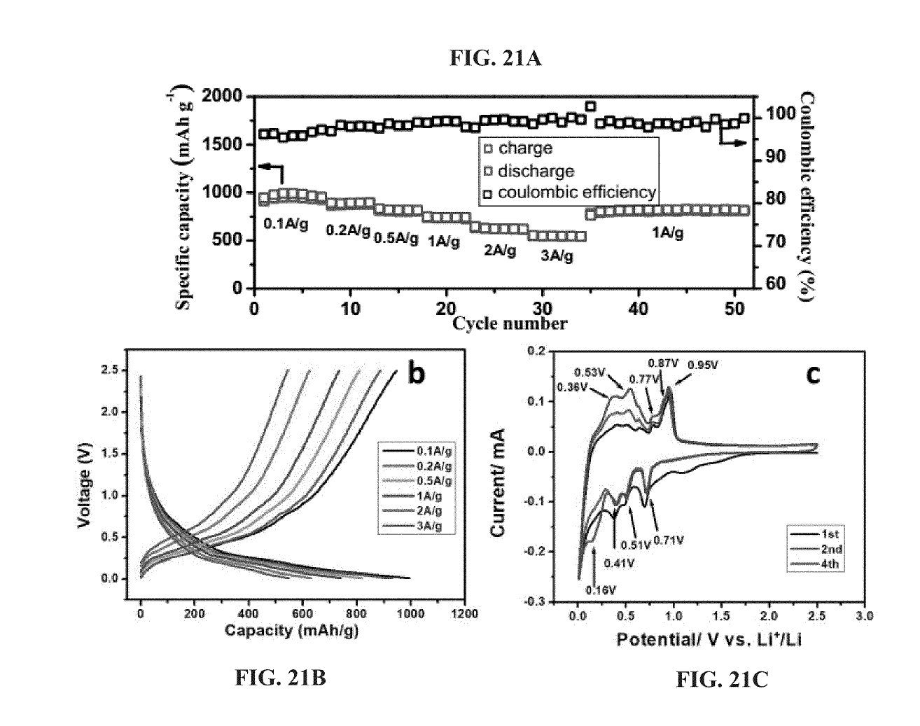

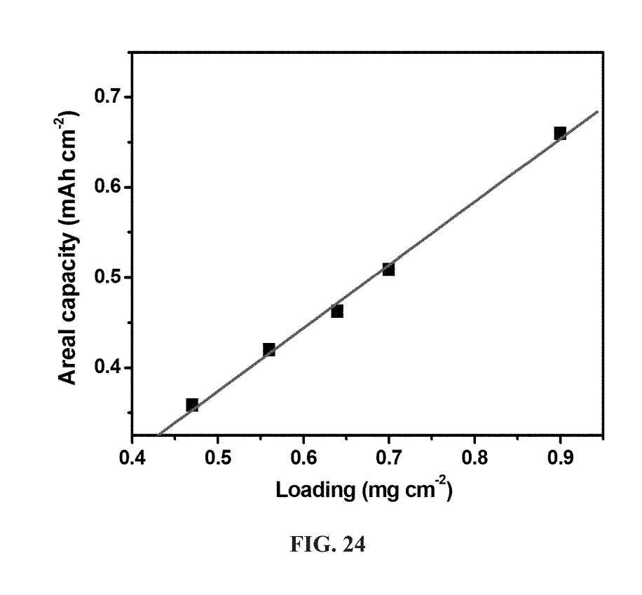

The high current rate tolerance of the SLC anode was achieved due to the geometric confinement effect and the high conductivity of the LM coated on the Si surface. FIG. 21A-FIG. 21C shows the rate capability of the SLC: the capacities at 100, 200, 500, 1,000, 2,000, and 3,000 mA/g are 950, 878, 807, 735, 618, and 546 mAh/g, respectively. After cycling at 3,000 mA/g, the capacity at 1,000 mA/g went back to 805 mAh/g, suggesting a total recovery. In addition, the dependence of electrode areal capacity on the mass loading was investigated and shown in FIG. 24. The areal capacity is based on delithiation capacity at the 20^{th} cycle at the 1 A/g rate. As the mass loading increased from 0.47 to 0.9 mg cm⁻², the electrode areal capacity shows a good linearity from 0.36 to 0.66 mAh cm⁻². This result indicated that high electrochemical activity was preserved due to our self-healing LM.

To further characterize the electrochemical performance of the SLC, the cyclic voltammetry (CV) test was performed at the rate of 0.05 mV/s and in the voltage range of 0.01-2.5 V (versus Li⁺/Li). In the first cycle, there are irreversible peaks, which are associated with the SEI layer formation (˜1.2 V) and the reduction of oxygen groups. After the first few cycles, the redox reactions became stable at the fourth cycle. The cathodic lithium insertion mainly occurs at 0.41 V for the Sn, at 0.51 and 0.71 V for the Ga, and at 0.16 V for Si; the anodic lithium extraction occurs at 0.87 V for the Sn, at 0.77, 0.95 V for the Ga, and 0.36 and 0.53 V for Si. These results all agree well with previous reports.

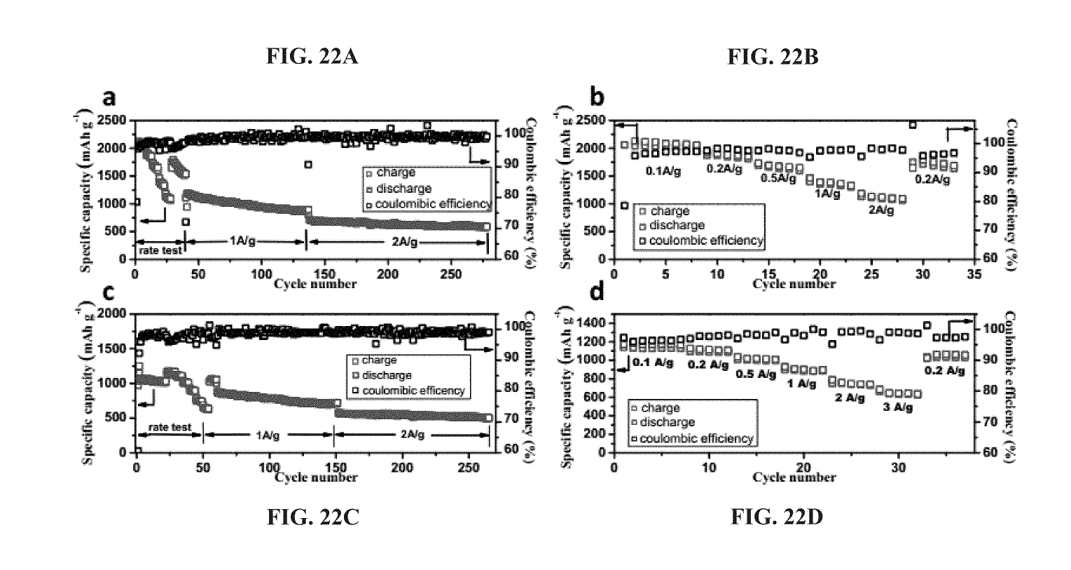

In the whole SLC anode, Si remedies the low-capacity shortcoming of the LM, while the LM buffers the problem of the huge volume change of the Si; therefore, the ratio of the Si/LM is important to the performance of the SLC anode. Further control experiments were carried out to understand the relationship. FIG. 22 shows the cyclic performance and rate capability of the SLC with different Si/LM ratios. With the increasing Si/LM ratio (2:1, named SLC₂ᵥ₁), the initial capacity of the anode increased gradually and can reach ˜2,000 mAh/g (FIG. 22A, at a current density of 100 mA/g); however, the capacity quickly dropped to 584 mAh/g after 300 cycles at 2,000 mA/g, which is even smaller than the capacity of Si/LM with a ratio of 1:2. The SLC_{2V1} also showed a poor C-rate performance: due to the high percentage of the Si, the capacity is quite high at the beginning, but it cannot fully recover, as the SLC retained only 87% capacity after 24 cycles rate test (FIG. 22B).

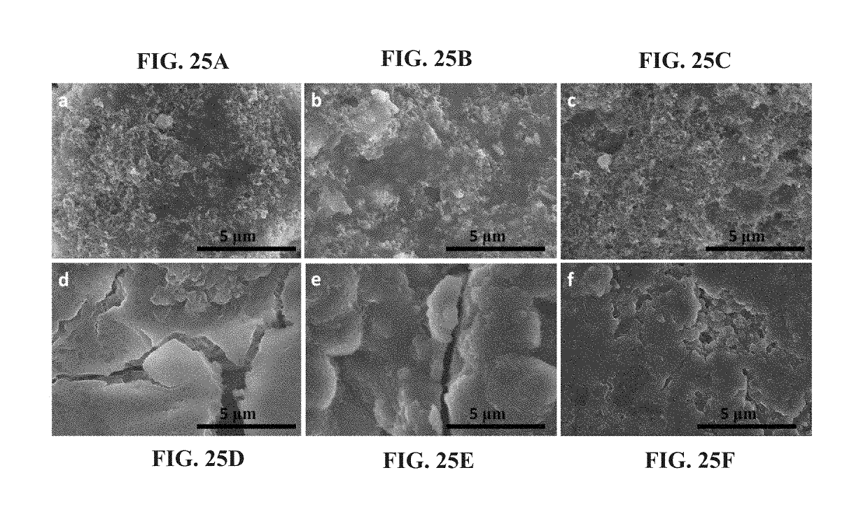

The SLC_{1V1} anode (Si/LM with a ratio of 1:1), which has an Si/LM ratio in between the SLC_{2V1} and SLC, showed an in-between performance (FIG. 22C and FIG. 22D): the initial capacity was lower than that of SLC_{2V1} but higher than that of SLC; after 250 cycles, the capacity of SLC_{1V1} turned higher than that of SLC_{2V1} but lower than that of SLC. This trend clearly shows the role of the LM in the SLC: an optimum amount of LM occurs when it can fully cover the Si nanoparticle and leave enough buffer space for the volume change. The LM was in the liquid state whose shape could be easily changed when a force was applied and would not destroy the whole carbon skeleton. Combined with the self-healing ability of LM, such a buffer will not lose this outstanding ability during cycling and thus lead to long-lasting cycle performance. But with a lower LM ratio there is not enough regulated space for the Si, and thus the volume change can crash the carbon skeleton nearby, destroy the conductive network, and cause crack formation. FIG. 25 shows the morphology of the anode before (FIG. 25A-FIG. 25C) and after (FIG. 25D-FIG. 25F) 100 cycles with different Si/LM ratios. There was no significant difference before cycling; after cycling, differentiation was caused by the Si/LM ratio. The anode with the higher Si ratio (SLC_{2V1}) had big, deep gullies caused by the volume change of the Si (FIG. 25D). The anode with an appropriate Si ratio (SLC) showed very little surface morphology change (FIG. 25F); there was no gully, as seen in FIG. 25D, and the conductivity network was well maintained. FIG. 25E is from the SLC_{1V1} after cycling, of which the Si/LM ratio is between SLC_{2V1} and SLC. The gullies of the SLC_{1V1} after cycling are not as deep as the SLC_{2V1} (FIG. 25D) and the conductivity network was not completely destroyed, leading to in-between battery performance between the SLC_{2V1} and SLC. All these results clearly suggest the role of LM and Si in the whole anode system.

In summary, LM was used as the self-healing liquid buffer, cooperating with the Si for the LIB anode. Si offers outstanding theoretical capacity while the LM works as the self-healing buffer and contributes to the capacity as well. Due to these advantages, the SLC anode delivered a high capacity of 950 mAh/g at 100 mA/g, and no obvious decay is observed with a capacity of ˜670 mAh/g at 2,000 mA/g over 1,000 cycles. The anode also had an outstanding rate performance with capacities of 950, 878, 807, 735, 618, and 546 mAh/g at 100, 200, 500, 1,000, 2,000, and 3,000 mA/g, respectively. This work provides a new route to overcome the capacity decay of the high-volume change anode materials, and can be extended to other applications calling for buffering or healing ability to support the host materials, such as in catalysis, various electrodes, artificial muscle, and intelligent materials.

### Example 3

### Electrospinning Liquid Metal Composite Materials

### Materials & Methods

Preparation of the Precursor for the Coaxial Electrospinning:

The compound of the outer layer was made by 12 wt % PAN (polyacrylonitrile) in DMF solution for 1 ml. For the inner layer, 20 mg LMNP was added into 1 ml DMF solution with 10 wt % PS (polystyrene).

Coaxial Electrospinning:

The coaxial electrospinning was done using a homemade instrument with a coaxial syringe needle. The fiber was collected by aluminum foil on a rotating collecting drum. The spin voltage was 15 KV, and the collecting distance was 15 cm. The flow rate of the outer layer is 1.1 ml/h, and 1 ml/h for the inner layer.

Preparation of the Electrode:

The aluminum foil with the fiber was peeled off from the rotating collecting drum. The fiber felt on the aluminum foil was clipped into small discs with the diameter of 12 mm. The small discs were annealed at 350 C in Ar for 0.5 h and then the fiber felts were separated from the aluminum foil. The freestanding fiber felts were annealed further at 800 C for 3 h and got the freestanding LMNP@carbon fiber felts for the electrode.

Electrochemical Characterization:

The electrochemical characterization was performed using the same protocol as described in Example 1. The charge/discharge performance was characterized by using 2032-type coin cells. Then, 1 M LiPF₆ dissolved in ethylene carbonate/ethyl methyl carbonate (40:60, v/v) was employed as the electrolyte, with 5 wt. % fluoroethylene carbonate and 1 wt. % vinylene carbonate as additives.

### Results & Discussion

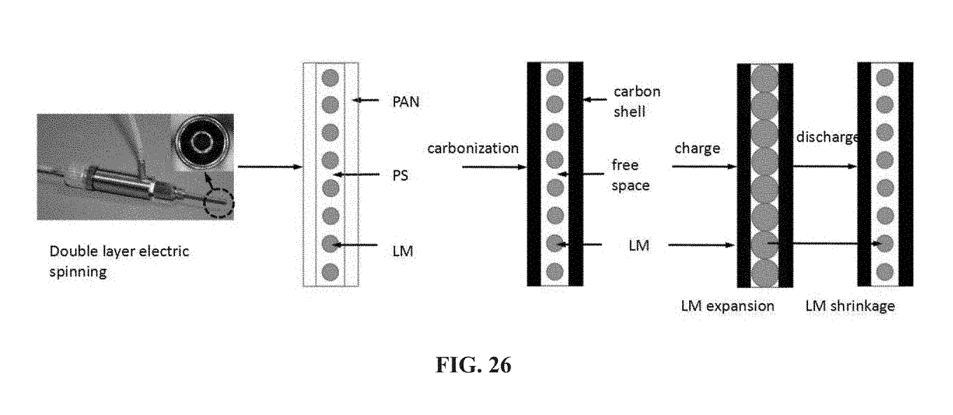

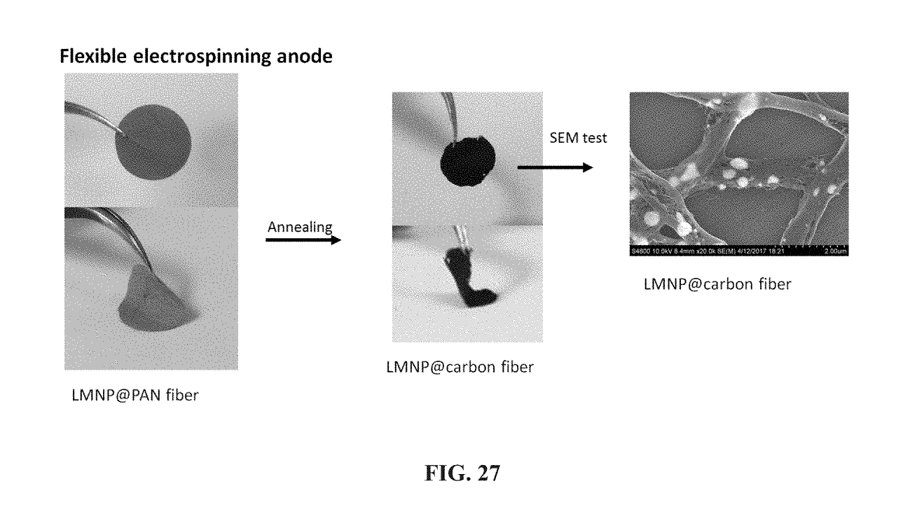

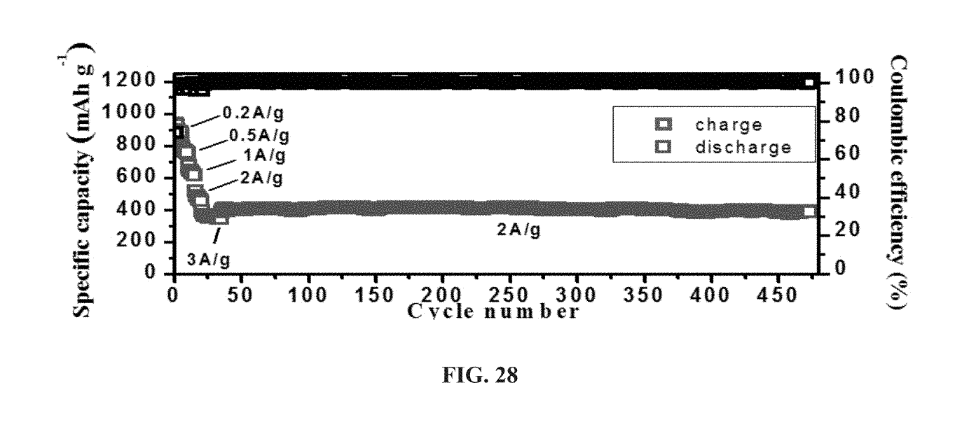

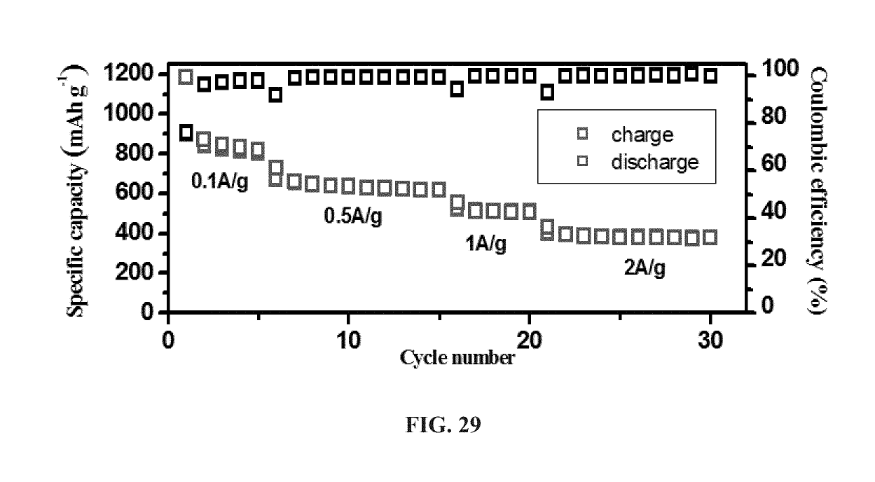

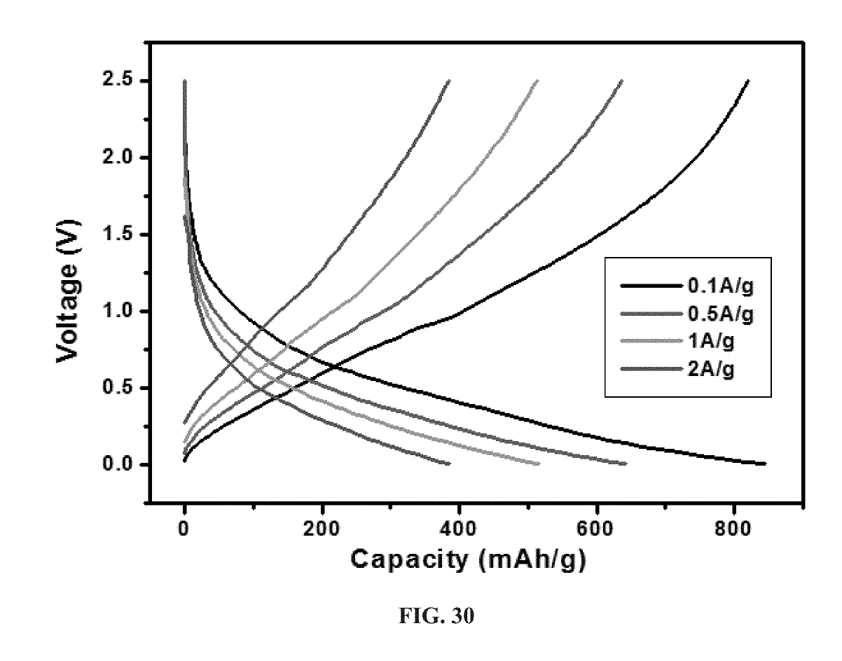

FIG. 26 illustrated the synthesis procedure for the LMNP@carbon fiber structure. The outer part was PAN with high carbon residual rate after annealing, which can be the carbon shell. FIG. 27 showed an image of the freestanding LMNP@PAN fiber felt before annealing and after annealing, which provided a LMNP@carbon fiber felt. The SEM in the FIG. 27 showed the microstructure of the LMNP@ carbon fiber felt. The inner part was PS and LMNP. The PS has a very low carbon residual rate, which gives free space after annealing. Such free space can buffer the volume change of the LM during the charge and discharge and will not destroy the carbon shell. The free space can also serve as the channel for the electrolyte transfer. Such structure can make full use of the seal-healing property of LM, and lead to a stable anode during the charge/discharge. FIG. 28 was the long cycle test of a LIB based on a LMNP@carbon fiber anode. The high reversible capacity still remained at ˜400 mAh/g with a C.E. more than 99.5% after 4,000 cycles at 2 A/g charge/discharge rate. And this anode showed a good rate performance (FIG. 29 and FIG. 30).

It is understood that the foregoing detailed description and accompanying examples are merely illustrative and are not to be taken as limitations upon the scope of the invention. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

For reasons of completeness, various aspects of the invention are set out in the following numbered clauses:

Clause 1. A composition comprising: a plurality of liquid metal particles; and a carbon-based scaffold comprising at least one of carbon nanotubes, reduced graphene oxide, carbon derived from an annealed carbon precursor, and a combination thereof.

Clause 2. The composition of clause 1, wherein the liquid metal has a melt temperature of about −60° C. to about 235° C.

Clause 3. The composition of clause 1 or 2, wherein the liquid metal particles each independently have a diameter of about 1 nm to about 2 μm.

Clause 4. The composition of any of clauses 1-3, wherein the liquid metal particles each independently have a surface that is modified by a surfactant.

Clause 5. The composition of any of clauses 1-4, wherein the liquid metal comprises Gallium (Ga) and Tin (Sn).

Clause 6. The composition of any of clauses 1-5, wherein the liquid metal is selected from: Zn_{3.6}Ga_{96.4}, In₇₆Ga₂₄, Ga_{62.5}In_{21.5}Sn₁₆, Ga₆₁In₂₅Sn₁₃Zn₁, Hg, Tl_{8.7}Hg_{91.3}, Ag₃₄Ga₆₆, and Ga₈₈Sn₁₂, wherein a subscript denotes an element's weight (wt) % of the liquid metal.

Clause 7. The composition of any of clauses 1-6, wherein the liquid metal particles are present at about 5 wt % to about 95 wt % as measured by wt % of the composition.

Clause 8. The composition of any of clauses 1-7, wherein the combination of the carbon nanotubes and reduced graphene oxide is present at about 1 wt % to about 25 wt % as measured by wt % of the composition.

Clause 9. The composition of any of clauses 1-8, wherein the carbon is derived from annealed polyacrylonitrile, annealed polyvinyl chloride, annealed polyvinyl alcohol, annealed polyethylene, annealed polyethylene oxide, annealed phenolic resin, or a combination thereof.

Clause 10. The composition of any of clauses 1-9, further comprising silicon particles, tin particles, aluminum particles, or a combination thereof.

Clause 11. The composition of any of clauses 1-10, further comprising silicon particles at a weight ratio (silicon particles:liquid metal particles) of about 4:1 to about 1:4.

Clause 12. The composition of clause 11, wherein the silicon particles each independently have a surface that is modified by a hydroxyl group.

Clause 13. A battery comprising: a first electrode comprising the composition of any of clauses 1-12; a second electrode; an electrolyte; and a separator.

Clause 14. The battery of clause 13, wherein the second electrode comprises Lithium (Li), LiCoO₂, LiFePO₄, LiFeSiO₄, LiMn₂O₄, sulfur, sulfide, a salt of Li, a salt of sodium (Na), a salt of Potassium (K), a salt of Magnesium (Mg), a salt of Aluminum (Al) or a combination thereof.

Clause 15. The battery of clause 13 or 14, wherein the electrolyte comprises a salt of Li, a salt of Na, a salt of K, a salt of Mg, a salt of Al, or a combination thereof.

Clause 16. The battery of any of clauses 13-15, wherein the battery has an operating temperature of about −60° C. to about 235° C.

Clause 17. The battery of any of clauses 13-16, wherein the battery provides a capacity of about 50 mAh/g to about 1,000 mAh/g at 2,000 mA/g after 1,000 cycles.

Clause 18. A method of making a liquid metal-based composition, the method comprising mixing at least two metals at a temperature of about 100° C. to about 1,000° C. to provide a liquid metal alloy; adding a surfactant to the liquid metal alloy and mechanically, electrically or both dispersing the surfactant and the liquid metal alloy to provide a plurality of liquid metal particles; mixing the plurality of liquid metal particles with at least one of carbon nanotubes, graphene oxide, a carbon precursor and a combination thereof to provide a mixture; and annealing the mixture to provide the composition of any of clauses 1-12.

Clause 19. The method of clause 18, wherein the at least two metals are selected from the group consisting of: Ga, Sn, Hg, Tl, Zn, In, Bi, Pb and Ag.

Clause 20. The method of clause 18 or 19, further comprising adding silicon particles to the liquid metal particles prior to mixing with at least one of carbon nanotubes, graphene oxide, a carbon precursor and a combination thereof.

Clause 21. The composition of any of clauses 1-12, wherein the carbon-based scaffold comprises reduced graphene oxide and at least one of carbon nanotubes, carbon derived from an annealed carbon precursor, and a combination thereof.

Clause 22. The composition of any of clauses 1-12, wherein the carbon-based scaffold comprises carbon nanotubes and reduced graphene oxide.

Clause 23. The composition of any of clauses 1-12, wherein the carbon-based scaffold comprises carbon derived from an annealed carbon precursor.

Clause 24. The composition of clause 23, wherein the carbon-based scaffold is in the form of a plurality of fibers.

Clause 25. The composition of clause 24, wherein the plurality of liquid metal particles are embedded within a core of each individual fiber.

What is claimed is:

1. A composition comprising:
a plurality of liquid metal particles; and
a carbon-based scaffold comprising at least one of carbon nanotubes, reduced graphene oxide, carbon derived from an annealed carbon precursor, and a combination thereof.

2. The composition of claim 1, wherein the liquid metal has a melt temperature of about −60° C. to about 235° C.

3. The composition of claim 1, wherein the liquid metal particles each independently have a diameter of about 1 nm to about 2 μm.

4. The composition of claim 1, wherein the liquid metal particles each independently have a surface that is modified by a surfactant.

5. The composition of claim 1, wherein the liquid metal comprises Gallium (Ga) and Tin (Sn).

6. The composition of claim 1, wherein the liquid metal is selected from:
Zn_{3.6}Ga_{96.4},
In₇₆Ga₂₄,
Ga_{62.5}In_{21.5}Sn₁₆,
Ga₆₁In₂₅Sn₁₃Zn₁,
Hg,
Tl_{8.7}Hg_{91.3},
Ag₃₄Ga₆₆, and
Ga₈₈Sn₁₂,
wherein a subscript denotes an element's weight (wt) % of the liquid metal.

7. The composition of claim 1, wherein the liquid metal particles are present at about 5 wt % to about 95 wt % as measured by wt % of the composition.

8. The composition of claim 1, wherein the combination of the carbon nanotubes and reduced graphene oxide is present at about 1 wt % to about 25 wt % as measured by wt % of the composition.

9. The composition of claim 1, wherein the carbon is derived from annealed polyacrylonitrile, annealed polyvinyl chloride, annealed polyvinyl alcohol, annealed polyethylene, annealed polyethylene oxide, annealed phenolic resin, or a combination thereof.

10. The composition of claim 1, further comprising silicon particles, tin particles, aluminum particles, or a combination thereof.

11. The composition of claim 1, further comprising silicon particles at a weight ratio (silicon particles:liquid metal particles) of about 4:1 to about 1:4.

12. The composition of claim 11, wherein the silicon particles each independently have a surface that is modified by a hydroxyl group.

13. A battery comprising:
a first electrode comprising the composition of claim 1;
a second electrode;
an electrolyte; and
a separator.

14. The battery of claim 13, wherein the second electrode comprises Lithium (Li), LiCoO₂, LiFePO₄, LiFeSiO₄, LiMn₂O₄, sulfur, sulfide, a salt of Li, a salt of sodium (Na), a salt of Potassium (K), a salt of Magnesium (Mg), a salt of Aluminum (Al) or a combination thereof.

15. The battery of claim 13, wherein the electrolyte comprises a salt of Li, a salt of Na, a salt of K, a salt of Mg, a salt of Al, or a combination thereof.

16. The battery of claim 13, wherein the battery has an operating temperature of about −60° C. to about 235° C.

17. The battery of claim 13, wherein the battery provides a capacity of about 50 mAh/g to about 1,000 mAh/g at 2,000 mA/g after 1,000 cycles.

18. A method of making a liquid metal-based composition, the method comprising
mixing at least two metals at a temperature of about 100° C. to about 1,000° C. to provide a liquid metal alloy;
adding a surfactant to the liquid metal alloy and mechanically, electrically or both dispersing the surfactant and the liquid metal alloy to provide a plurality of liquid metal particles;
mixing the plurality of liquid metal particles with at least one of carbon nanotubes, graphene oxide, a carbon precursor and a combination thereof to provide a mixture; and
annealing the mixture to provide the composition of claim 1.

19. The method of claim 18, wherein the at least two metals are selected from the group consisting of: Ga, Sn, Hg, Tl, Zn, In, Bi, Pb and Ag.

20. The method of claim 18, further comprising adding silicon particles to the liquid metal particles prior to mixing with at least one of carbon nanotubes, graphene oxide, a carbon precursor and a combination thereof.
